(19) United States
(12) Patent Application Publication
(10) Pub. No.: US 2026/0227564 A1
(43) Pub. Date: Aug. 6, 2026

(54) LIGHT GUIDE COLUMNS, LUMINAIRES, AND METHODS FOR MANUFACTURING LIGHT GUIDE COLUMNS

(71) Applicant: ZHONGSHAN ZHILAI LIGHTING CO., LTD., Zhongshan (CN)

(72) Inventor: Jinsheng OU, Zhongshan (CN)

(73) Assignee: ZHONGSHAN ZHILAI LIGHTING CO., LTD., Zhongshan (CN)

(21) Appl. No.: 19/540,613

(22) Filed: Feb. 14, 2026

Related U.S. Application Data
(63) Continuation of application No. PCT/CN2025/114068, filed on Aug. 12, 2025.

(30) Foreign Application Priority Data
Jan. 26, 2025 (CN) 202520174922.8

(51) Int. Cl. F21V 8/00; F21Y 115/10

(52) U.S. Cl. CPC G02B 6/0065; G02B 6/0068; F21Y 2115/10

(57) ABSTRACT

Provided are a light guide column, a luminaire, and a method for manufacturing a light guide column. The present disclosure relates to the field of lighting equipment. The light guide column includes a columnar structure. The columnar structure is made of a transparent material, an interior of the columnar structure includes at least one first annular region centered on an axis of the columnar structure, an interior of the first annular region has bubbles, and at least a portion of a luminous intensity distribution curve of the light guide column has a serrated pattern.

### CROSS-REFERENCE TO RELATED APPLICATIONS

This application is a continuation of International Application No. PCT/CN2025/114068, filed on August 12, 2025, which claims priority to Chinese Patent Application No. 202520174922.8, filed on January 26, 2025, the contents of each of which are hereby incorporated by reference.

### TECHNICAL FIELD

The present disclosure relates to the field of lighting equipment, and in particular, relates to a light guide column, a luminaire including the light guide column, a method for manufacturing a light guide column, and a design method for a process for manufacturing a light guide column.

### BACKGROUND

A light-emitting diode (LED) has unique light-emitting characteristics. Due to its small light-emitting area, an LED can be considered as a point light source and has excellent light-emitting consistency and a small solid angle. This means that light emitted by a single LED light-emitting unit forms a small beam in space, which has a relatively small light-emitting angle and is relatively concentrated.

To obtain a larger lighting effect, optical components such as a reflector cup or a lens can be added to adjust the light-emitting angle and light distribution of the LED light-emitting unit. However, due to the directional limitations of the reflector cup and the lens, a large angle or even 360° omnidirectional light emission cannot be achieved. An LED bulb can also use a milky lampshade for refraction to expand the irradiation angle, thereby enlarging the illumination area. However, a large-area milky lampshade affects the user's visual experience.

Therefore, it is necessary to provide a light guide column, a luminaire, and a method for manufacturing the light guide column. The light guide column can achieve large-angle or even 360° omnidirectional light emission while providing a transparent illumination area for a good visual experience.

### SUMMARY

One or more embodiments of the present disclosure provide a light guide column. The light guide column includes a columnar structure. The columnar structure is made of a transparent material, an interior of the columnar structure includes at least one first annular region centered on an axis of the columnar structure, an interior of the at least one first annular region has bubbles; and at least a portion of a luminous intensity distribution curve of the light guide column has a serrated pattern.

In some embodiments, the interior of the columnar structure further includes one or more second regions centered on the axis of the columnar structure, and the at least one first annular region and the one or more second regions are alternately arranged; and the one or more second regions do not contain a bubble.

In some embodiments, the one or more second regions are one or more second annular regions.

In some embodiments, the luminous intensity distribution curve of the light guide column includes a first intensity distribution region and two second intensity distribution regions located on both sides of the first intensity distribution region; the luminous intensity distribution curve in the first intensity distribution region has a transverse trend; the luminous intensity distribution curve in each of the two second intensity distribution regions has an increasing trend or a decreasing trend; at least one of the luminous intensity distribution curve in the first intensity distribution region and the luminous intensity distribution curve in the each of the two second intensity distribution regions has the serrated pattern.

In some embodiments, the luminous intensity distribution curve in the first intensity distribution region has the serrated pattern; the luminous intensity distribution curve in the each of the two second intensity distribution regions includes a smooth section having a smooth shape and a serrated section having the serrated pattern, and the serrated section is adjacent to the first intensity distribution region.

In some embodiments, a count of the at least one first annular region is one, and an inner diameter of the first annular region is greater than or equal to half of a diameter of the columnar structure.

In some embodiments, a diameter of each of the bubbles is in a range of 1.5 to 2 mm, and a maximum spacing between adjacent bubbles is selected from a range of 10 to 15 mm.

In some embodiments, a 50% beam angle of the light guide column is greater than 100°.

In some embodiments, a count of the at least one first annular region is one, and an outer diameter of the first annular region is less than or equal to half of a diameter of the columnar structure.

In some embodiments, a diameter of each of the bubbles is in a range of 3 to 4 mm, and a maximum spacing between adjacent bubbles is selected from a range of 8 to 10 mm.

In some embodiments, a 50% beam angle of the light guide column is in a range of 85 to 95°.

In some embodiments, a diameter of each of the bubbles is in a range of 5 to 7 mm, and a maximum spacing between adjacent bubbles is selected from a range of 3 to 6 mm.

In some embodiments, a 50% beam angle of the light guide column is in a range of 80 to 90°.

In some embodiments, a count of the at least one first annular region is two or more, and the bubbles include first bubbles and second bubbles; an interior of one or more of the at least one first annular region has the first bubbles, and an interior of one or more remaining first annular regions has the second bubbles.

In some embodiments, a diameter of each of the first bubbles is less than a diameter of each of the second bubbles.

In some embodiments, a first annular region containing the first bubbles surrounds an exterior of a first annular region containing the second bubbles.

In some embodiments, the diameter of each of the first bubbles is in a range of 1.5 to 2 mm, and a maximum spacing between adjacent first bubbles is selected from a range of 8 to 10 mm; and/or, the diameter of each of the second bubbles is in a range of 5 to 7 mm, and a maximum spacing between adjacent second bubbles is selected from a range of 3 to 6 mm.

In some embodiments, a count of the at least one first annular region is one, the bubbles include third bubbles and fourth bubbles, and a diameter of each of the third bubbles is less than a diameter of each of the fourth bubbles.

In some embodiments, the diameter of each of the third bubbles is in a range of 1.5 to 2 mm, the diameter of each of the fourth bubbles is in a range of 5 to 7 mm, and a maximum spacing between adjacent bubbles is selected from a range of 3 to 6 mm.

In some embodiments, a 50% beam angle of the light guide column is in a range of 92 to 98°.

In some embodiments, the light guide column includes a first light-emitting surface and a second light-emitting surface, the first light-emitting surface is provided by at least a portion of an outer circumferential surface of the columnar structure, and the second light-emitting surface is provided by at least a portion of an end surface of one end of the columnar structure; the second light-emitting surface is a flat surface.

One or more embodiments of the present disclosure provide a luminaire. The luminaire includes: a housing, wherein one end of the housing is fixedly connected to the light guide column; a light source assembly, wherein the light source assembly is disposed within the housing.

In some embodiments, the housing includes: a first housing, wherein one end of the first housing is fixedly connected to the light guide column; a second housing, wherein the second housing is fixedly connected to the first housing, and the second housing closes another end of the first housing; the light source assembly is disposed within a first accommodation space formed by the first housing and the second housing, the first housing has a step portion, and the light source assembly is mounted on the step portion.

In some embodiments, the first housing includes: a first cylindrical structure, a second annular structure, and a third cylindrical structure connected in sequence; a diameter of the first cylindrical structure is greater than a diameter of the third cylindrical structure, a step surface of the step portion is formed at the second annular structure, and a circuit board of the light source assembly is fixed to the second annular structure.

In some embodiments, the columnar structure of the light guide column has a second accommodation space, and at least a portion of the first housing is disposed within the second accommodation space; the columnar structure of the light guide column is threadedly connected to the first housing.

In some embodiments, the luminaire further includes a diffusing plate. The diffusing plate is disposed within the second accommodation space. The diffusing plate is configured to convert one or more point light sources provided by the light source assembly into a surface light source directed toward the columnar structure of the light guide column.

In some embodiments, an outer diameter of the diffusing plate matches an outer diameter of an end of the first housing proximate to the columnar structure, one end of the first housing abuts against one side of the diffusing plate, and another side of the diffusing plate contacts a bottom surface of the second accommodation space.

In some embodiments, the second annular structure is provided with a heat dissipation hole.

One or more embodiments of the present disclosure provide a method for manufacturing a light guide column. The light guide column includes a columnar structure, the columnar structure is made of a transparent material, an interior of the columnar structure includes at least one first annular region centered on an axis of the columnar structure, and an interior of the at least one first annular region has bubbles; at least a portion of a luminous intensity distribution curve of the light guide column has the serrated pattern. The method includes: providing a light guide column material, wherein the light guide column material includes a material for forming the at least one first annular region, and the material includes a plastic material, a fast-acting foaming agent, and a slow-acting foaming agent; performing temperature control and pressure control on the light guide column material to form the bubbles inside the light guide column material; performing cooling control on the light guide column material to cure the light guide column material, to obtain the light guide column.

In some embodiments, the interior of the columnar structure includes a first annular region and one or more second regions centered on the axis of the columnar structure. The method includes: providing the light guide column material, the light guide column material including a first material for forming the one or more second regions located on an inner portion, a second material for forming the first annular region located in a middle portion, and a third material for forming the one or more second regions located on an outer portion, wherein each of the first material and the third material include the plastic material, and the second material includes the plastic material, the fast-acting foaming agent, and the slow-acting foaming agent.

In some embodiments, an effective decomposition temperature range of the fast-acting foaming agent partially overlaps an effective decomposition temperature range of the slow-acting foaming agent; a lowest effective decomposition temperature of the fast-acting foaming agent is lower than a highest effective decomposition temperature of the slow-acting foaming agent, and a highest effective decomposition temperature of the fast-acting foaming agent is higher than the highest effective decomposition temperature of the slow-acting foaming agent; a lowest effective decomposition temperature of the slow-acting foaming agent is lower than the lowest effective decomposition temperature of the fast-acting foaming agent, and the highest effective decomposition temperature of the slow-acting foaming agent is higher than the lowest effective decomposition temperature of the fast-acting foaming agent.

In some embodiments, the fast-acting foaming agent is an azodicarbonamide foaming agent, and the effective decomposition temperature range of the azodicarbonamide foaming agent is 195-220°C; the slow-acting foaming agent is a sodium bicarbonate-citric acid foaming agent, and the effective decomposition temperature range of the sodium bicarbonate-citric acid foaming agent is 160-200°C.

In some embodiments, the performing temperature control and pressure control on the light guide column material to form the bubbles inside the light guide column material includes: causing the light guide column material to be at a first temperature and a first pressure, to melt the plastic material while avoiding decomposition of the fast-acting foaming agent and the slow-acting foaming agent; causing the light guide column material to be at a second temperature and a second pressure, to initiate decomposition of the slow-acting foaming agent, wherein the second temperature is within the effective decomposition temperature range of the slow-acting foaming agent, the second temperature is lower than the lowest effective decomposition temperature of the fast-acting foaming agent, and the second pressure is lower than the first pressure; causing the light guide column material to be at a third temperature and a third pressure, to initiate decomposition of the fast-acting foaming agent, wherein the third temperature is within the effective decomposition temperature range of the slow-acting foaming agent and the effective decomposition temperature range of the fast-acting foaming agent, and the third pressure is lower than the second pressure; causing the light guide column material to be at a fourth temperature and a fourth pressure, to reduce or suppress decomposition of the fast-acting foaming agent, wherein the fourth temperature is lower than the lowest effective decomposition temperature of the fast-acting foaming agent, the fourth pressure includes a peripheral pressure and a central pressure, and the peripheral pressure is greater than the central pressure.

In some embodiments, the second material includes, by mass parts: 98.8-99.5 parts of the plastic material, 0.2-0.4 parts of the fast-acting foaming agent, and 0.8-1 part of the slow-acting foaming agent. A diameter of each of the bubbles of the light guide column is in a range of 1.5-2 mm, and a maximum spacing between adjacent bubbles is selected from a range of 10-15 mm.

In some embodiments, the first temperature is 160±1°C, and the first pressure is 1.2±0.1 MPa; the second temperature is 180±1°C, and the second pressure is 0.9±0.1 MPa; the third temperature is 195±1°C, and the third pressure is 0.6±0.1 MPa; the fourth temperature is 170±1°C, the peripheral pressure of the fourth pressure is 1.5±0.1 MPa, and the central pressure of the fourth pressure is 0.6±0.1 MPa.

In some embodiments, the second material includes, by mass parts: 97.8-98.7 parts of the plastic material, 0.5-0.7 parts of the fast-acting foaming agent, and 0.5-0.7 parts of the slow-acting foaming agent; a diameter of each of the bubbles of the light guide column is in a range of 3-4 mm, and a maximum spacing between adjacent bubbles is selected from a range of 8-10 mm.

In some embodiments, the first temperature is 170±1°C, and the first pressure is 1.3±0.1 MPa; the second temperature is 200±1°C, and the second pressure is 0.8±0.1 MPa; the third temperature is 215±1°C, and the third pressure is 0.5±0.1 MPa; the fourth temperature is 190±1°C, the peripheral pressure of the fourth pressure is 1.5±0.1 MPa, and the central pressure of the fourth pressure is 0.5±0.1 MPa.

In some embodiments, the performing temperature control and pressure control on the light guide column material to form the bubbles inside the light guide column material includes: causing the light guide column material to be at a first temperature and a first pressure, to melt the plastic material while avoiding decomposition of the fast-acting foaming agent and the slow-acting foaming agent; causing the light guide column material to be at a second temperature and a second pressure, to initiate decomposition of the slow-acting foaming agent and the fast-acting foaming agent, wherein the second temperature is within the effective decomposition temperature range of the slow-acting foaming agent and the effective decomposition temperature range of the fast-acting foaming agent, and the second pressure is lower than the first pressure; causing the light guide column material to be at a third temperature and a third pressure, to further decompose the fast-acting foaming agent, wherein the third temperature is higher than the highest effective decomposition temperature of the fast-acting foaming agent, and the third pressure is lower than the second pressure; causing the light guide column material to be at a fourth temperature and a fourth pressure, to reduce decomposition of the fast-acting foaming agent, wherein the fourth temperature is within the effective decomposition temperature range of the slow-acting foaming agent and the effective decomposition temperature range of the fast-acting foaming agent, the fourth temperature is lower than the second temperature, the fourth pressure includes a peripheral pressure and a central pressure, and the peripheral pressure is greater than the central pressure.

In some embodiments, the second material includes, by mass parts: 96-97.5 parts of the plastic material, 0.8-1 part of the fast-acting foaming agent, and 0.3-0.45 parts of the slow-acting foaming agent; a diameter of each of the bubbles of the light guide column is in a range of 5-7 mm, and a maximum spacing between adjacent bubbles is selected from a range of 3-6 mm.

In some embodiments, the first temperature is 180±1°C, and the first pressure is 1.5±0.1 MPa; the second temperature is 210±1°C, and the second pressure is 0.6±0.1 MPa; the third temperature is 230±1°C, and the third pressure is 0.2±0.1 MPa; the fourth temperature is 200±1°C, the peripheral pressure of the fourth pressure is 1.0±0.1 MPa, and the central pressure of the fourth pressure is 0.2±0.1 MPa.

In some embodiments, the performing temperature control and pressure control on the light guide column material to form the bubbles inside the light guide column material includes: causing the light guide column material to be at a first temperature and a first pressure, to melt the plastic material while avoiding decomposition of the fast-acting foaming agent and the slow-acting foaming agent; causing the light guide column material to be at a second temperature and a second pressure, to initiate decomposition of the slow-acting foaming agent and the fast-acting foaming agent, wherein the second temperature is within the effective decomposition temperature range of the slow-acting foaming agent and the effective decomposition temperature range of the fast-acting foaming agent, and the second pressure is lower than the first pressure; causing the light guide column material to be at a third temperature and a third pressure, to completely decompose the fast-acting foaming agent, wherein the third temperature is within the effective decomposition temperature range of the slow-acting foaming agent and the effective decomposition temperature range of the fast-acting foaming agent, or the third temperature is equal to the highest effective decomposition temperature of the fast-acting foaming agent, the third temperature is higher than the second temperature, and the third pressure is lower than the second pressure; causing the light guide column material to be at a fourth temperature and a fourth pressure, to reduce decomposition of the fast-acting foaming agent, wherein the fourth temperature is within the effective decomposition temperature range of the slow-acting foaming agent and the effective decomposition temperature range of the fast-acting foaming agent, the fourth temperature is lower than the second temperature, the fourth pressure includes a peripheral pressure and a central pressure, and the peripheral pressure is greater than the central pressure.

In some embodiments, the second material includes, by mass parts: 97.5 parts of the plastic material, 0.5 parts of the fast-acting foaming agent, and 0.8 parts of the slow-acting foaming agent; the bubbles of the light guide column includes third bubbles and fourth bubbles, a diameter of each of the third bubbles is in a range of 1.5-2 mm, a diameter of each of the fourth bubbles is in a range of 5-7 mm, and a maximum spacing between adjacent bubbles is selected from a range of 3-6 mm.

In some embodiments, the first temperature is 175±1°C, and the first pressure is 1.3±0.1 MPa; the second temperature is 200±1°C, and the second pressure is 0.7±0.1 MPa; the third temperature is 220±1°C, and the third pressure is 0.4±0.1 MPa; the fourth temperature is 195±1°C, the peripheral pressure of the fourth pressure is 1.2±0.1 MPa, and the central pressure of the fourth pressure is 0.4±0.1 MPa.

In some embodiments, the interior of the columnar structure includes the at least one first annular region and one or more second regions centered on the axis of the columnar structure, the at least one first annular region and the one or more second regions are alternately arranged sequentially from a center of the columnar structure to an outer portion of the columnar structure, a count of the at least one first annular region is at least two, an interior of one of the at least one first annular region has first bubbles, and an interior of another of the at least one first annular region has second bubbles. The method includes: the light guide column material includes a first material for forming a second region located on an inner portion, a second material and a third material for forming two first annular regions located in a middle portion, a fourth material for forming a second region located between the two first annular regions, and a fifth material for forming a second region located on an outer portion, each of the second material and the third material includes the plastic material, the fast-acting foaming agent, and the slow-acting foaming agent, and each of the first material, the fourth material, and the fifth material includes the plastic material; independently performing temperature control and pressure control on the second material and the third material respectively, to independently form the first bubbles and the second bubbles inside the second material and the third material respectively; independently performing cooling control on the second material and the third material respectively, to cure the light guide column material to obtain the light guide column.

In some embodiments, an effective decomposition temperature range of the fast-acting foaming agent partially overlaps with an effective decomposition temperature range of the slow-acting foaming agent; a lowest effective decomposition temperature of the fast-acting foaming agent is lower than a highest effective decomposition temperature of the slow-acting foaming agent, and a highest effective decomposition temperature of the fast-acting foaming agent is higher than the highest effective decomposition temperature of the slow-acting foaming agent; a lowest effective decomposition temperature of the slow-acting foaming agent is lower than the lowest effective decomposition temperature of the fast-acting foaming agent, and the highest effective decomposition temperature of the slow-acting foaming agent is higher than the lowest effective decomposition temperature of the slow-acting foaming agent.

In some embodiments, the fast-acting foaming agent is an azodicarbonamide foaming agent, and an effective decomposition temperature range of the azodicarbonamide foaming agent is 195-220°C; the slow-acting foaming agent is a sodium bicarbonate-citric acid foaming agent, and an effective decomposition temperature range of the sodium bicarbonate-citric acid foaming agent is 160-200°C.

In some embodiments, the independently performing temperature control and pressure control on the second material and the third material respectively, to independently form the first bubbles and the second bubbles inside the second material and the third material respectively includes: melting the second material and the third material, while avoiding decomposition of the fast-acting foaming agent and the slow-acting foaming agent, and providing different pressures to the second material and the third material; setting a temperature of the second material within the effective decomposition temperature range of the slow-acting foaming agent and the effective decomposition temperature range of the fast-acting foaming agent, to initiate decomposition of the slow-acting foaming agent and the fast-acting foaming agent; setting a temperature of the third material within the effective decomposition temperature range of the slow-acting foaming agent and lower than the lowest effective decomposition temperature of the fast-acting foaming agent, to initiate decomposition of the slow-acting foaming agent; setting the temperature of the second material higher than or equal to the highest effective decomposition temperature of the fast-acting foaming agent, to completely decompose the fast-acting foaming agent; setting the temperature of the third material within the effective decomposition temperature range of the slow-acting foaming agent and the effective decomposition temperature range of the fast-acting foaming agent, to decompose the slow-acting foaming agent and the fast-acting foaming agent; reducing the temperature of the second material and the temperature of the third material, to set positions of the two first annular regions.

In some embodiments, the setting a temperature of the second material within the effective decomposition temperature range of the slow-acting foaming agent and the effective decomposition temperature range of the fast-acting foaming agent, to initiate decomposition of the slow-acting foaming agent and the fast-acting foaming agent; and setting a temperature of the third material within the effective decomposition temperature range of the slow-acting foaming agent and lower than the lowest effective decomposition temperature of the fast-acting foaming agent, to initiate decomposition of the slow-acting foaming agent, further includes: performing first stirring on the second material, and performing second stirring on the third material; a stirring speed of the first stirring is greater than a stirring speed of the second stirring.

In some embodiments, the reducing the temperature of the second material and the temperature of the third material, to set the positions of the two first annular regions, further includes: providing an inner layer pressure to the second material, providing a middle layer pressure to the fourth material, and providing an outer layer pressure to the third material, wherein the outer layer pressure is greater than the middle layer pressure, and the middle layer pressure is greater than the inner layer pressure.

In some embodiments, providing the light guide column material includes: providing the first material, the fourth material, and the fifth material, and after a first time interval, providing the second material and the third material. An injection speed of each of the first material, the fourth material, and the fifth material is greater than an injection speed of the second material. The injection speed of each of the first material, the fourth material, and the fifth material is greater than an injection speed of the third material. The injection speed of the second material is less than the injection speed of the third material.

One or more embodiments of the present disclosure provide a design method for a process for manufacturing a light guide column. The light guide column includes: a columnar structure, the columnar structure is made of a transparent material, an interior of the columnar structure includes at least one first annular region and one or more second regions centered on an axis of the columnar structure, an interior of each of the at least one first annular region has bubbles; at least a portion of a luminous intensity distribution curve of the light guide column has a serrated pattern. The design method includes: providing at least one first material barrel in a count corresponding to a count of the at least one first annular region, and providing one or more second material barrels; providing, based on parameters of the bubbles inside the each of the at least one first annular region, a first annular region material with corresponding composition to a first material barrel corresponding to the each of the at least one first annular region, the first annular region material including a plastic material, a fast-acting foaming agent, and a slow-acting foaming agent; providing a second region material to the one or more second material barrels, the second region material including a plastic material; providing molding parameters for the first annular region material and the second region material based on the parameters of the bubbles inside the each of the at least one first annular region; providing cooling parameters for the first annular region material and the second region material based on the parameters of the bubbles inside the each of the at least one first annular region.

In some embodiments, the parameters of the bubbles include: a size of the bubbles and a spacing of the bubbles.

In some embodiments, the providing molding parameters for the first annular region material and the second region material based on the parameters of the bubbles inside the each of the at least one first annular region includes: obtaining an effective decomposition temperature range of the fast-acting foaming agent and an effective decomposition temperature range of the slow-acting foaming agent; obtaining a molding objective for each of one or more molding zones based on the parameters of the bubbles inside the each of the at least one first annular region, and obtaining an operating state of the fast-acting foaming agent and an operating state of the slow-acting foaming agent correspondingly based on the molding objective; obtaining the molding parameters based on the operating state of the fast-acting foaming agent and the operating state of the slow-acting foaming agent; the one or more molding zones includes at least one of a feeding zone, a melting zone, a foaming activation zone, or a fusion zone.

In some embodiments, the obtaining the molding objective for each of the one or more molding zones based on the parameters of the bubbles inside the each of the at least one first annular region includes: obtaining a current bubble state to be achieved in each of the one or more molding zones based on the parameters of the bubbles inside the first annular region; the current bubble state includes: bubble generation, gas expansion of the bubbles, decompression expansion of the bubbles, suppression of bubble expansion, promotion of bubble coalescence, promotion of bubble position retention, and promotion of bubble migration.

In some embodiments, the molding parameters include temperature molding parameters and pressure molding parameters; obtaining the molding parameters based on the operating state of the fast-acting foaming agent and the operating state of the slow-acting foaming agent includes: selecting the temperature molding parameters from the effective decomposition temperature range of the fast-acting foaming agent and the effective decomposition temperature range of the slow-acting foaming agent based on the operating state of the fast-acting foaming agent and the operating state of the slow-acting foaming agent; obtaining the pressure molding parameters based on the parameters of the bubbles and the temperature molding parameters.

In some embodiments, the cooling parameters include: at least one of a count of cooling zones, a cooling medium corresponding to each of the cooling zones, a cooling temperature corresponding to the each of the cooling zones, a cooling flow rate corresponding to the each of the cooling zones, or a cooling rate corresponding to the each of the cooling zones.

### BRIEF DESCRIPTION OF THE DRAWINGS

The present disclosure will be further illustrated by way of exemplary embodiments, which will be described in detail by means of the accompanying drawings. The same reference numerals in the drawings denote the same structures or steps.

FIG. 1 is a schematic diagram illustrating a front view of a light guide column according to some embodiments of the present disclosure;

FIG. 2 is a schematic diagram illustrating a cross-sectional view of a light guide column according to some embodiments of the present disclosure;

FIG. 3 is a schematic diagram illustrating a first annular region and a second annular region of a light guide column according to some embodiments of the present disclosure;

FIG. 4 is a schematic diagram illustrating a perspective view of a light guide column according to some embodiments of the present disclosure;

FIG. 5 is a schematic diagram illustrating a three-dimensional view of a light guide column according to some embodiments of the present disclosure;

FIG. 6 is a schematic diagram illustrating a partial enlarged view of FIG. 5;

FIG. 7 is a schematic diagram illustrating a front view of a luminaire according to some embodiments of the present disclosure;

FIG. 8 is a schematic diagram illustrating a bottom view of a luminaire according to some embodiments of the present disclosure;

FIG. 9 and FIG. 10 are schematic diagrams illustrating three-dimensional views of a luminaire according to some embodiments of the present disclosure;

FIG. 11 is a schematic diagram illustrating a three-dimensional view of a first housing, a second housing, and a light source assembly of a luminaire according to some embodiments of the present disclosure;

FIG. 12 is a schematic diagram illustrating a cross-sectional view of a first housing, a second housing, and a light source assembly of a luminaire according to some embodiments of the present disclosure;

FIG. 13 is a schematic diagram illustrating a partial enlarged view of FIG. 12;

FIG. 14 is a schematic diagram illustrating an assembly view of a diffusing plate of a luminaire according to some embodiments of the present disclosure;

FIG. 15 is a schematic diagram illustrating a light guide column with a single layer of small bubbles in an outer portion according to some embodiments of the present disclosure;

FIG. 16 is a schematic diagram illustrating a luminous intensity distribution curve of a light guide column with the single layer of small bubbles in the outer portion shown in FIG. 15;

FIG. 17 is a schematic diagram illustrating a light guide column with a single layer of medium bubbles in a middle part according to some embodiments of the present disclosure;

FIG. 18 is a schematic diagram illustrating a luminous intensity distribution curve of the light guide column with the single layer of medium bubbles in the middle part shown in FIG. 17;

FIG. 19 is a schematic diagram illustrating a light guide column with a single layer of large bubbles in an inner portion according to some embodiments of the present disclosure;

FIG. 20 is a schematic diagram illustrating a luminous intensity distribution curve of a light guide column with the single layer of large bubbles in the inner portion shown in FIG. 19;

FIG. 21 is a schematic diagram illustrating a light guide column with double-layer bubbles according to some embodiments of the present disclosure;

FIG. 22 is a schematic diagram illustrating a light guide column with a single layer of mixed large bubbles and small bubbles in an inner portion according to some embodiments of the present disclosure;

FIG. 23 is a schematic diagram illustrating a luminous intensity distribution curve of the light guide column with the single layer of mixed large bubbles and small bubbles in the inner portion shown in FIG. 22;

FIG. 24 is a schematic diagram illustrating a measurement plane for a luminous intensity distribution curve of a light guide column according to some embodiments of the present disclosure;

FIG. 25 is an exemplary flowchart illustrating a process for manufacturing a light guide column according to some embodiments of the present disclosure;

FIG. 26 is an exemplary flowchart illustrating a design process for a method for manufacturing a light guide column according to some embodiments of the present disclosure;

FIG. 27 is a schematic diagram illustrating a manufacturing apparatus for a light guide column according to some embodiments of the present disclosure;

FIG. 28 is a schematic diagram illustrating a discharge outlet of a manufacturing apparatus for a light guide column according to some embodiments of the present disclosure.

Reference numerals used in the drawings are as follows. 1: columnar structure; 1a: first light-emitting surface; 1b: second light-emitting surface; 11: second accommodation space; 11a: bottom surface; 21: first annular region; 22: second annular region; 3: bubble; 41: first housing; 411: first cylindrical structure; 412: second annular structure; 413: third cylindrical structure; 414: heat dissipation hole; 42: second housing; 43: first accommodation space; 5: light source assembly; 51: circuit board; 6: diffusing plate; A: first intensity distribution region; B: second intensity distribution region.

### DETAILED DESCRIPTION

The technical solutions in the embodiments of the present disclosure will be clearly and completely described below in conjunction with the accompanying drawings in the embodiments of the present disclosure. Obviously, the following descriptions are some examples or embodiments of the present disclosure. For those of ordinary skill in the art, without creative effort, the technical solutions or means disclosed in the present disclosure can also be applied to other scenarios based on these technical contents.

It should be understood that the terms "system", "device", "equipment", "part" and/or "component", "unit" and/or "module" used in the present disclosure are methods for distinguishing components, elements, parts, sections, or assemblies of different levels. However, if other words can achieve the same purpose, the words can be replaced by other expressions.

Unless otherwise specified, the technical terms describing components, elements, etc., in the present disclosure do not specifically refer to the singular form and may also include the plural form. Generally, terms such as "include" and "comprise" only indicate the inclusion of explicitly identified steps, elements, or components. These steps, elements, and components do not constitute an exclusive list. For example, the described method or device may also include other steps or components.

In the description of the present disclosure, it should be understood that terms related to orientation descriptions, such as up, down, front, rear, left, right, etc., indicate orientations or positional relationships based on the orientations or positional relationships shown in the accompanying drawings. These terms are used only to facilitate the description of the present disclosure and to simplify the description, and do not indicate or imply that the referred device or element must have a specific orientation or be constructed and operated in a specific orientation. Therefore, these terms should not be construed as limiting the present disclosure. In the description of the present disclosure, unless explicitly defined, otherwise, terms such as "set", "install", and "connect" should be understood broadly. Those skilled in the art can reasonably determine the specific meanings of these terms in the present disclosure based on the specific content of the technical solution.

An LED is a semiconductor device that can convert electrical energy into light energy. In some embodiments, an LED may include an n-type semiconductor and a p-type semiconductor. When the two semiconductor materials contact, a p-n junction is formed. When a forward voltage is applied, electrons enter the p-type region from the n-type region and recombine with holes to release energy. In some embodiments, the energy can be released in the form of photons, thereby generating a light emission phenomenon.

LED light source devices having LED light-emitting units are gradually replacing traditional bulbs (e.g., tungsten filament lamps, incandescent lamps) due to sufficient luminous brightness, uniform light emission, and low power consumption. With the further development of lighting technology, LED light source devices have gradually formed various models of bulb light sources. However, the light emission characteristics of an LED are unique. Due to its small light-emitting area, it can be regarded as a point light source, having excellent light emission consistency and a small solid angle. This means that light emitted by a single LED light-emitting unit forms a small beam in space, with a relatively small light emission angle and relatively concentrated light.

In some related embodiments, to obtain a larger lighting effect, optical components such as a reflector cup or a lens can be added to adjust the light emission angle and light distribution of the LED light-emitting unit. However, due to the directional limitations of the reflector cup and the lens, large-angle or even 360° omnidirectional light emission cannot be achieved. In other related embodiments, an LED bulb can also use a milky lampshade for refraction to expand the irradiation angle, thereby enlarging the illumination area. However, a large-area milky lampshade affects the visual experience of a user.

Therefore, one or more embodiments of the present disclosure provide a light guide column and a luminaire including the light guide column. The light guide column can achieve large-angle or even 360° omnidirectional light emission while providing a transparent illumination area for a good visual experience.

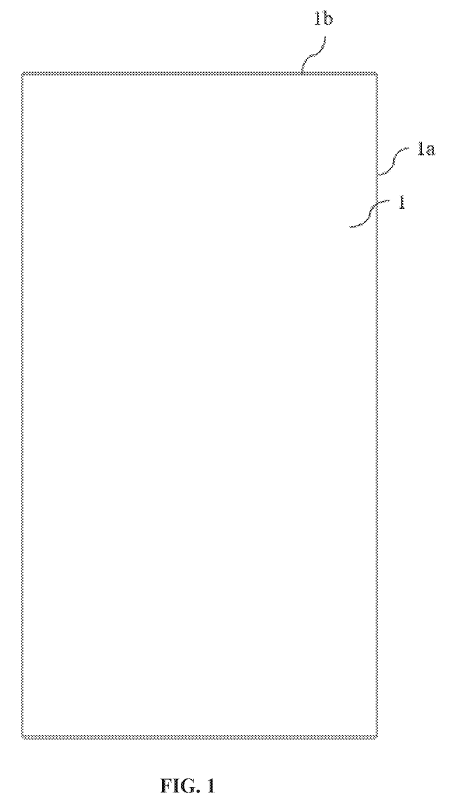

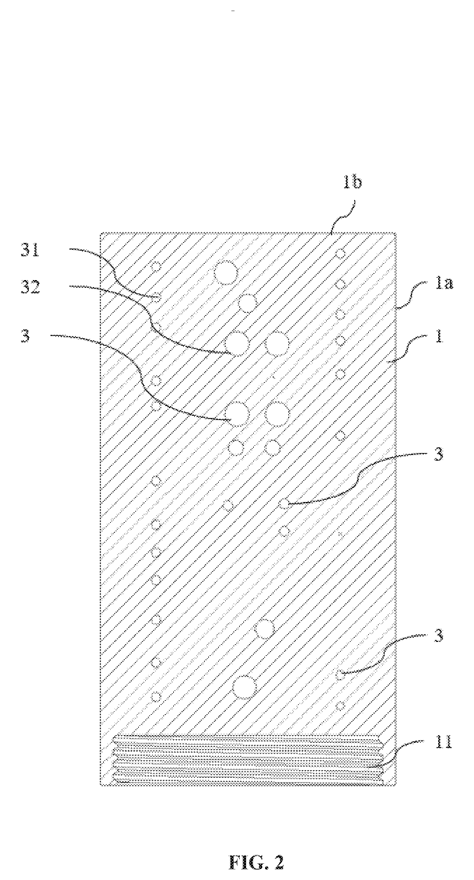

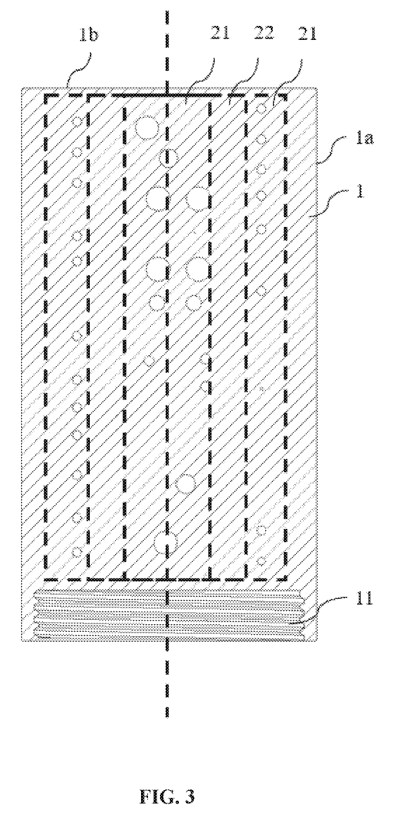

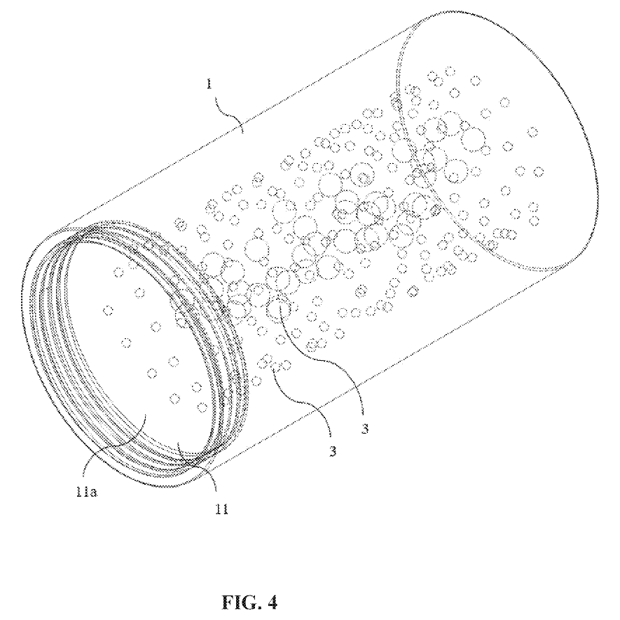

FIG. 1 is a schematic diagram illustrating a front view of a light guide column according to some embodiments of the present disclosure. FIG. 2 is a schematic diagram illustrating a cross-sectional view of a light guide column according to some embodiments of the present disclosure. FIG. 3 is a schematic diagram illustrating a first annular region and a second annular region of a light guide column according to some embodiments of the present disclosure. FIG. 4 is a schematic diagram illustrating a perspective view of a light guide column according to some embodiments of the present disclosure. As shown in FIGS. 1-4, in one or more embodiments of the present disclosure, a light guide column may include a columnar structure 1. In some embodiments, the columnar structure 1 may refer to a structure that extends along a certain axis direction and has a specific geometric shape. In some embodiments, an axis of the columnar structure 1 may be a straight line or a curved line.

In some embodiments, the columnar structure 1 may be formed by enclosing two parallel flat surfaces and a curved surface. In some embodiments, the columnar structure 1 has two equal bottom surfaces. A shape of a bottom surface may be circular, elliptical, polygonal, or other irregular closed shapes.

In some embodiments, all cross-sections of the columnar structure 1 may be similar or identical to the bottom surface. In some embodiments, all cross-sections of the columnar structure 1 are identical, so that the columnar structure 1 has the same diameter in the axis direction. In some embodiments, all cross-sections of the columnar structure 1 are similar figures, so that the columnar structure 1 has a varying diameter in the axis direction. In some embodiments, the diameter of the columnar structure 1 in the axis direction changes continuously, for example, gradually increasing, gradually decreasing, increasing then decreasing, or decreasing then increasing.

In some embodiments, a side surface of the columnar structure 1 may include a plurality of parallelograms, for example, including a plurality of rectangles. In some embodiments, the columnar structure 1 may be a right column, for example, a side surface of the columnar structure 1 is perpendicular to a bottom surface. In other embodiments, the columnar structure 1 may also be an oblique column, for example, there is an angle between a side surface of the columnar structure 1 and a bottom surface.

Merely by way of example, the columnar structure 1 may be a polygonal columnar structure such as a rectangular right prism structure, a cylindrical structure or an elliptical cylindrical structure, an inclined cylindrical structure or elliptical cylindrical structure, a columnar structure with a star-shaped cross-section, a right prism or oblique prism structure where a bottom surface and a cross-section parallel to the bottom surface are both irregular curved surfaces, etc.

In other embodiments, the columnar structure 1 may refer to a closed geometric body formed by a plane curve rotating around an axis in its plane for one revolution to form a curved surface, which is then intercepted by two parallel planes. In some embodiments, the two bottom surfaces of the columnar structure 1 may have different sizes. In some embodiments, a cross-section of the columnar structure 1 may have a shape similar to but with different dimensions from a bottom surface.

For example, the columnar structure 1 may be frustum-shaped, drum-shaped, or the like.

In one or more embodiments of the present disclosure, the columnar structure 1 is made of a transparent material. In some embodiments, a material of the columnar structure 1 may be a glass material or a plastic material. In some embodiments, the plastic material may specifically be a resin material. In some embodiments, the columnar structure 1 may be made of a colorless transparent material or a colored transparent material.

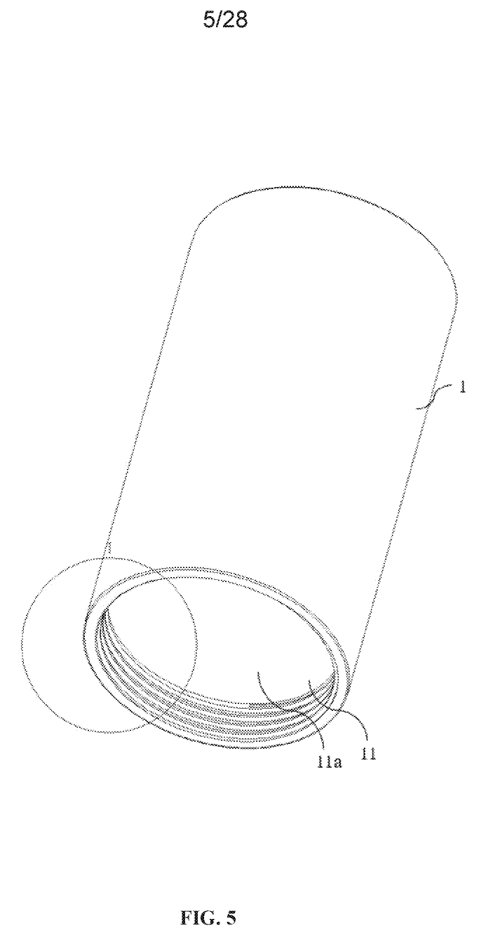

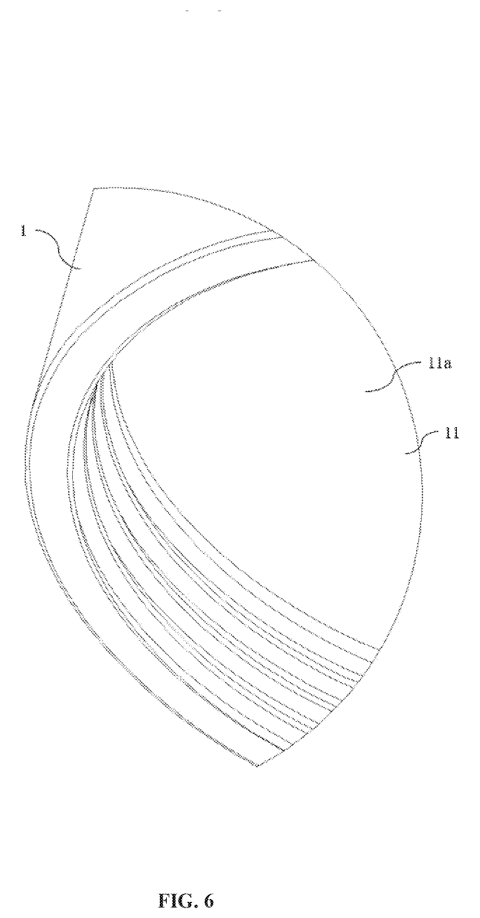

In some embodiments, as shown in FIG. 5 and FIG. 6, a second accommodation space 11 for accommodating other assemblies may be formed in the columnar structure 1 of the light guide column. In some embodiments, the second accommodation space 11 may have a top bottom surface and a side surface. In some embodiments, threads may be formed on the side surface of the second accommodation space 11 for connection with other assemblies.

In some embodiments, the columnar structure 1 of the light guide column may be connected to other assemblies in other forms. For example, an end surface of the columnar structure 1 of the light guide column may be a flat surface, and the flat surface is adhered to another assembly. For example, a buckle is provided at one end of the columnar structure 1 of the light guide column for detachably connecting to another assembly via the buckle. As another example, an external thread is provided at one end of the columnar structure 1 of the light guide column for connection by engaging with an internal thread of another structure.

In one or more embodiments of the present disclosure, an interior of the columnar structure 1 of the light guide column includes at least one first annular region 21 centered on an axis of the columnar structure 1, and an interior of the first annular region 21 includes bubbles 3. In some embodiments, a bubble 3 is a cavity structure formed inside the columnar structure 1. In some embodiments, an interior of a bubble 3 may contain a gas. In some embodiments, the gas inside the bubble 3 may include one or more of nitrogen, carbon monoxide, carbon dioxide, etc. In some embodiments, a bubble 3 may be formed by gas generated from an inorganic compound under specific conditions, e.g., sodium bicarbonate, ammonium bicarbonate, ammonium chloride, sodium carbonate, or the like. For example, a bubble 3 may also be formed by gas generated from a compound capable of undergoing a chemical change, e.g., an azo compound, a sulfonyl hydrazide compound, a nitroso compound, or the like. In other embodiments, the interior of the bubble 3 may not contain a gas.

In some embodiments, the bubbles 3 inside the first annular region 21 are arranged substantially in a ring. In some embodiments, the interior of the first annular region 21 may include one ring of bubbles 3. In other embodiments, the interior of the first annular region 21 may include a plurality of rings of bubbles 3. In yet other embodiments, the interior of the first annular region 21 may include a bubble-containing region and a bubble-free region, and one ring or a plurality of rings of bubbles 3 may be located within the bubble-containing region.

In some embodiments, a middle portion of the first annular region 21 in a radial direction includes bubbles 3, while an outer portion and/or an inner portion of the first annular region 21 in the radial direction does not include bubbles 3. In other embodiments, the interior of the first annular region 21 includes bubbles 3 from an inner portion to an outer portion in the radial direction.

In some embodiments, the first annular region 21 may be formed by a material corresponding to the first annular region 21 provided during manufacturing of the light guide column. In some embodiments, the material corresponding to the first annular region 21 may include a foaming agent, thereby forming bubbles inside the first annular region 21. In this embodiment, during formation of the first annular region 21, the bubbles 3 may be uniformly distributed inside the first annular region 21, thereby resulting in a situation where the bubbles 3 are present from the inner portion to the outer portion within the first annular region 21 (i.e., the bubbles 3 are dispersed in the radial direction of the first annular region 21). In this embodiment, during formation of the first annular region 21, after the bubbles 3 are uniformly distributed inside the first annular region 21, temperature control and/or pressure control may cause migration of the positions of the bubbles 3 within the first annular region 21, thereby causing the bubbles 3 to move inward and/or outward, thus resulting in a situation where the outer portion and/or inner portion of the first annular region 21 does not have bubbles 3 (i.e., the bubbles 3 are concentrated in the middle portion of the radial direction of the first annular region 21).

In some embodiments, the interior of the columnar structure 1 includes one first annular region 21. In other embodiments, the interior of the columnar structure 1 includes two first annular regions 21. In yet other embodiments, the interior of the columnar structure 1 includes more than two first annular regions 21, e.g., three or four first annular regions 21. In some embodiments, there is a region without bubbles 3 between the plurality of first annular regions 21.

In some embodiments, the interior of the columnar structure 1 may further include one or more second regions 22. In some embodiments, an interior of the one or more second regions 22 does not include bubbles. In one or more embodiments of the present disclosure, the interior of the one or more second regions 22 not including bubbles refers to an absence of intentionally formed bubbles resulting from a design process. However, in some practical scenarios, the interior of the one or more second regions 22 may contain bubbles (also referred to as cavities) arising from process defects, limitations in process precision, or other unavoidable factors. In one or more embodiments of the present disclosure, the interior of the one or more second regions 22 not including bubbles refers to that more than 95% of a region of the interior of the one or more second regions 22 does not include bubbles. For example, the region of the interior of the one or more second regions 22 that does not include bubbles occupies more than 95% of a volume of the interior of the one or more second regions 22. In some embodiments, the one or more second regions 22 may be centered on the axis of the columnar structure 1. In some embodiments, the one or more second regions 22 may be one or more second annular regions. In some embodiments, the at least one first annular region 21 and the second annular region may be alternately arranged, thereby forming patterns such as "bubble-free - bubble-containing - bubble-free", "bubble-free - bubble-containing - bubble-free - bubble-containing - bubble-free", or "bubble-containing - bubble-free - bubble-containing" from the center to the outside.

As an example, as shown in FIG. 3 and FIG. 4, the interior of the columnar structure 1 includes the at least one first annular region 21 and the one or more second regions 22 alternately arranged sequentially from a center of the columnar structure 1 to an outer portion of the columnar structure 1. A count of the at least one first annular region 21 may be one or more, e.g., two or more.

In some embodiments, a first annular region 21 is provided at a center position of the columnar structure 1, and a second region 22 is provided surrounding the first annular region 21. In some further embodiments, another first annular region 21 may surround the second region 22, and another second region 22 may surround the another first annular region 21, thereby achieving an alternating arrangement. In other embodiments, the second region 22 is disposed at a central position of the columnar structure 1, and the first annular region 21 is disposed surrounding the second region 22, and so on.

In some embodiments, the at least one first annular region 21 and the one or more second regions 22 may be alternately arranged in a plurality of layers. Merely by way of example, a first annular region 21 and a second region 22 may form an annular region group. An interior of the columnar structure 1 may include one or more annular region groups, for example, two or more annular region groups.

In some embodiments, the first annular region 21 may be disposed at a central position of the columnar structure 1, or the second region 22 may be disposed at the central position. Merely by way of example, from the center of the columnar structure 1 to the outer surface of the columnar structure 1, annular regions may be arranged in an order of the first annular region 21, the second region 22, the first annular region 21, and the second region 22. Alternatively, the annular regions may be arranged in an order of the second region 22, the first annular region 21, the second region 22, and the first annular region 21.

In some embodiments, the second region 22 may be formed by a material corresponding to the second region 22 provided during manufacturing of the light guide column. In some embodiments, the material corresponding to the second region 22 does not include a foaming agent, so that bubbles are not formed inside the second region 22. In other words, the second region 22 is a solid region.

In one or more embodiments of the present disclosure, the first annular region 21 has bubbles 3 inside. In some embodiments, the second region 22 does not have a bubble 3 inside. In some embodiments, a material forming the columnar structure 1 may not be microscopically dense. The second region 22 not having a bubble 3 inside may refer to the second region 22 not having a bubble 3 visible to the naked eye.

In some embodiments, the second region 22 forms a spacing region that separates two adjacent first annular regions 21 having bubbles 3.

In some embodiments, the columnar structure 1 forms a plurality of rings of bubbles 3 at a plurality of layers of the first annular region 21. In some embodiments, two adjacent rings of bubbles 3 (e.g., between two adjacent first annular regions 21) are separated by the second region 22. In some embodiments, a structure between two adjacent rings of bubbles 3 is a solid structure.

In some embodiments, a shape of the first annular region 21 and a shape of the second region 22 may be set based on a shape of an outer surface of the columnar structure 1. Merely by way of example, if the columnar structure 1 has a rectangular columnar structure, an axial cross-section of the first annular region 21 may be a rectangle with smaller side lengths, and an axial cross-section of the second region 22 may be a rectangle with larger side lengths. Merely by way of example, if the columnar structure 1 has a frustum shape, the first annular region 21 as a whole may be a conical ring with a smaller diameter that does not include an apex, and the second region 22 as a whole may be a conical ring with a larger diameter that does not include the apex.

In other embodiments, the shape of the first annular region 21 and the shape of the second region 22 may also be set without considering the shape of the outer surface of the columnar structure 1. Merely by way of example, the columnar structure 1 may have a rectangular columnar structure, while both the first annular region 21 and the second region 22 may have a circular ring shape. Merely by way of example, the columnar structure 1 may have a drum-like structure, while both the first annular region 21 and the second region 22 may have a circular ring shape.

In some embodiments, shapes of the bubbles 3 may be the same or different. In some embodiments, the bubbles 3 may be circular or approximately circular. In some embodiments, the bubbles 3 are formed based on gas expansion inside the columnar structure 1. In some embodiments, the bubbles 3 are formed as approximately circular structures under the combined action of factors such as a fluid pressure of the material of the columnar structure 1 in a mold and a gas pressure of the gas forming the bubbles 3 (formed by gas pressures resulted from different amounts of gas generated by the material under temperature control and pressure control). In other embodiments, the bubbles 3 may also have irregular shapes.

In one or more embodiments of the present disclosure, the first annular region 21 extends in an axial direction of the columnar structure 1. A count of bubbles 3 inside the first annular region 21 is a plurality. In some embodiments, the bubbles inside the first annular region 21 are distributed from one bottom surface of the columnar structure 1 (e.g., a lower surface in FIG. 1) to the other bottom surface (e.g., an upper surface in FIG. 1).

In some embodiments, the second region 22 extends in an axial direction of the columnar structure 1.

In some embodiments, an annular region (e.g., the first annular region 21 or the second region 22) may refer to a partial spatial region within the columnar structure 1. In some embodiments, the annular region may include two annular bottom surface portions and a spatial portion extending in the axial direction between the two annular bottom surfaces. In some embodiments, the spatial portion of the annular region has a certain volume. In some embodiments, within a same first annular region 21, the bubbles 3 may be randomly distributed in a radial direction and/or the axial direction. Merely by way of example, within a same first annular region 21, one or more bubbles 3 may be distributed along the radial direction, and one or more bubbles 3 may also be distributed along the axial direction. Merely by way of example, within a same first annular region 21, a plurality of bubbles 3 may be arranged in an interleaved manner in the radial direction and/or the axial direction, to achieve a more uniform and complex light refraction effect. Merely by way of example, in two first annular regions 21, bubbles 3 in one first annular region 21 ma y be arranged in an interleaved manner in the axial direction relative to bubbles 3 in the other first annular region 21 (e.g., one or more bubbles 3 in the first annular region 21 are located at different radial planar layers in the axial direction relative to one or more bubbles 3 in the other first annular region 21, or a projection of one or more bubbles 3 in the first annular region 21 in the radial direction has a non-overlapping portion relative to a projection of one or more bubbles 3 in the other first annular region 21), to form a more uniform overall light distribution effect.

In some embodiments, an outer surface of the columnar structure 1 of the light guide column may be a smooth surface. In other embodiments, the outer surface of the columnar structure 1 of the light guide column may have a pattern. Merely by way of example, the outer surface of the columnar structure 1 of the light guide column may have a rib structure extending along its axial direction. Merely by way of example, the outer surface of the columnar structure 1 of the light guide column may include a plurality of protrusion structures. The plurality of protrusion structures are arranged in a ring array around the outer surface of the columnar structure 1 of the light guide column. A protrusion structure may be a circular protrusion, a frustum-shaped protrusion, a prismatic protrusion, a pyramidal frustum protrusion, etc. Merely by way of example, the outer surface of the columnar structure 1 of the light guide column may have a knurled pattern. Merely by way of example, the outer surface of the columnar structure 1 of the light guide column may have an irregular wavy pattern.

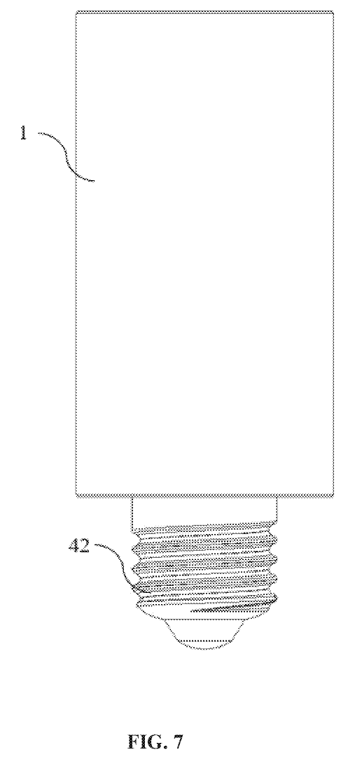

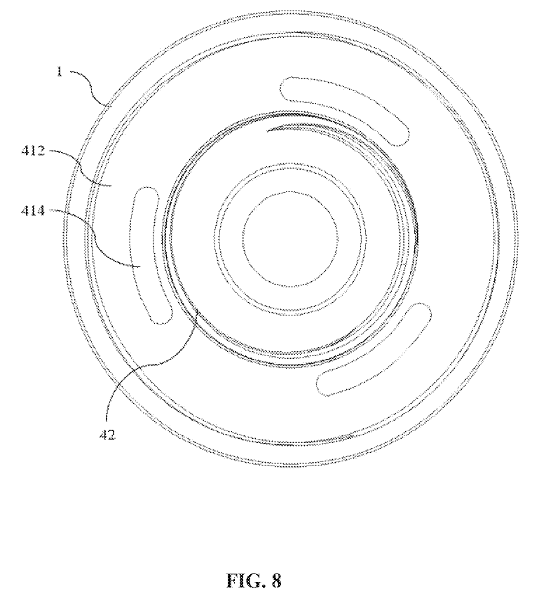

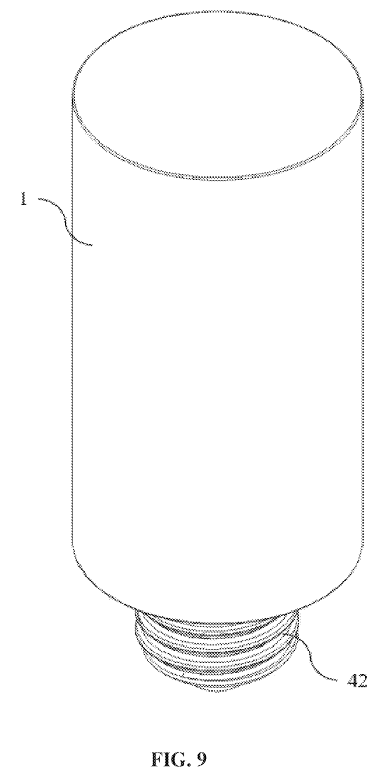

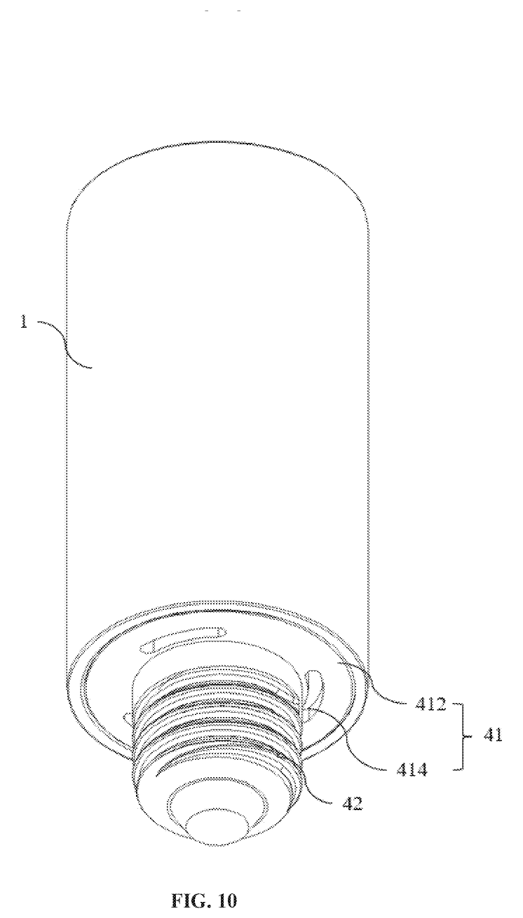

FIG. 7 is a schematic diagram illustrating a front view of a luminaire according to some embodiments of the present disclosure. FIG. 8 is a schematic diagram illustrating a bottom view of a luminaire according to some embodiments of the present disclosure. FIG. 9 and FIG. 10 are schematic diagrams illustrating three-dimensional views of a luminaire according to some embodiments of the present disclosure. As shown in FIG. 7 to FIG. 10 and in conjunction with FIG. 1 to FIG. 6, in one or more embodiments of the present disclosure, a luminaire may include a light guide column, a housing 4, and a light source assembly 5. One end of the housing 4 is fixedly connected to the light guide column. The light source assembly 5 is disposed within the housing 4. In some embodiments, as shown in FIG. 5 and FIG. 6, the second accommodation space 11 may be provided in the columnar structure 1 of the light guide column for accommodating other assemblies. In some embodiments, the second accommodation space 11 may have the top bottom surface and the side surface. In some embodiments, threads on the side surface of the second accommodation space 11 may be connected to the housing 4.

In some embodiments, the housing 4 may include a first housing 41 and a second housing 42. One end of the first housing 41 is fixedly connected to the light guide column. The second housing 42 is fixedly connected to the first housing 41. The second housing 42 closes the other end of the first housing 41. In some embodiments, the first housing 41 and the second housing 42 form a housing for accommodating the light source assembly 5. In some embodiments, the first housing 41 and the second housing 42 may form a bulb base. In some embodiments, a light source is powered via the bulb base, thereby generating a light emission phenomenon. In some embodiments, the light source assembly 5 is disposed within a first accommodation space 43 formed by the first housing 41 and the second housing 42. The first housing 41 has a step portion. The light source assembly 5 is mounted on the step portion. In some embodiments, the light source assembly 5 provides an LED light source. In other embodiments, the light source assembly 5 may also provide other light sources besides the LED light source.

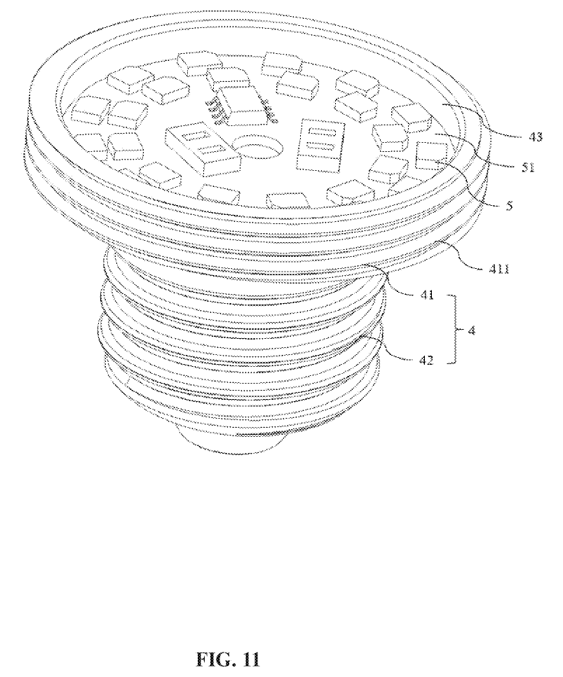

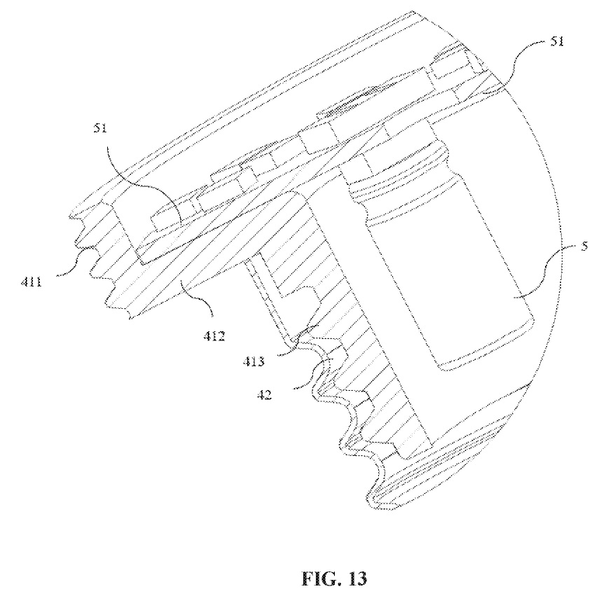

In one or more embodiments of the present disclosure, as shown in FIG. 11 to FIG. 13, the first housing 41 includes a first cylindrical structure 411, a second annular structure 412, and a third cylindrical structure 413 connected sequentially. In some embodiments, a diameter of the first cylindrical structure 411 is greater than a diameter of the third cylindrical structure 413. A step surface of the step portion is formed at the second annular structure 412. A circuit board 51 of the light source assembly 5 is fixed to the second annular structure 412. In some embodiments, the circuit board 51 of the light source assembly 5 may be annular. In some embodiments, a light-emitting unit (e.g., the LED light-emitting unit) of the light source assembly 5 may be arranged on one side of the circuit board 51, and an electrical component (e.g., a capacitor) of the light source assembly 5 may be arranged on the other side of the circuit board 51. In some embodiments, the light-emitting unit may be disposed within the first cylindrical structure 411. In some embodiments, the light-emitting unit may be arranged facing the light guide column. In some embodiments, the electrical component may be disposed within the third cylindrical structure 413.

In some embodiments, one or more LED light-emitting units may be arranged on the circuit board 51. In some embodiments, a plurality of rings of LED light-emitting units may be arranged on the circuit board 51. In some embodiments, an outer diameter of the circuit board 51 may match a diameter of the light guide column. In other embodiments, an outer diameter of the circuit board 51 may be less than a diameter of the light guide column.

In some embodiments, an LED light-emitting unit may include a plurality of 1800K lamp beads. The plurality of 1800K lamp beads may be arranged in an annular distribution. In some embodiments, a light emission angle of an LED light-emitting unit may be 120°. In some embodiments, the plurality of 1800K lamp beads are configured to emit light statically, to form a monochromatic warm amber glow with a water ripple effect.

In other embodiments, an LED light-emitting unit may include a plurality of 3000K lamp beads or a plurality of 5000K lamp beads, to form a radial warm light beam or a cool white glow.

As another example, an LED light-emitting unit may have different light colors. Merely by way of example, an LED light-emitting unit may include a plurality of RGB lamp beads. In this embodiment, the LED light-emitting unit may be configured to emit light dynamically. In some embodiments, each RGB lamp bead may change its light color sequentially according to a specific color sequence, for example, emitting light in the order of red→orange→yellow→green→cyan→blue→purple. Based on reflection and refraction provided by the columnar structure 1, a complex and delicate superimposed gradient glow is formed.

In some embodiments, the columnar structure 1 of the light guide column has the second accommodation space 11. At least a portion of the first housing 41 is disposed within the second accommodation space 11. In some embodiments, an outer wall of the first housing 41 may be provided with an external thread matching an inner wall of the second accommodation space 11. In some embodiments, the columnar structure 1 of the light guide column is threadedly connected to the first housing 41.

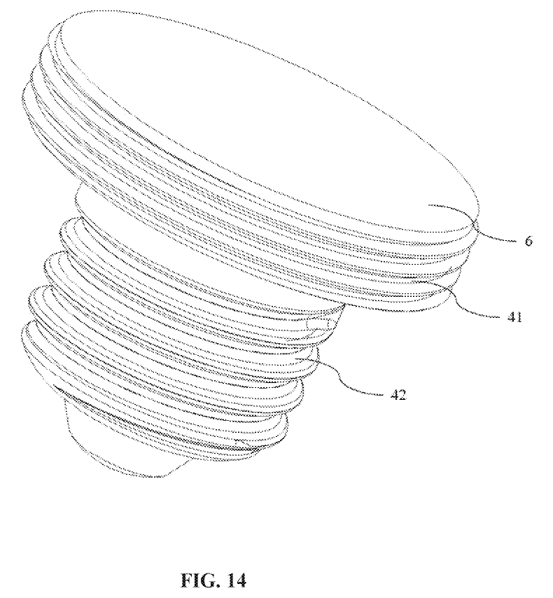

In one or more embodiments of the present disclosure, as shown in FIG. 14, the luminaire may further include a diffusing plate 6. The diffusing plate 6 is disposed within the second accommodation space 11. In some embodiments, the diffusing plate 6 has a thin sheet structure. In some embodiments, the diffusing plate 6 may be milky white. In other embodiments, the diffusing plate 6 may also be set to other colors. In some embodiments, the diffusing plate 6 may be translucent. In some embodiments, the diffusing plate 6 is hidden within the second accommodation space 11, so that when a user observes the luminaire, only an aesthetically pleasing transparent structure is visible, and a large-area milky white diffusing lampshade cannot be observed.

In some embodiments, the diffusing plate 6 is configured to convert one or more point light sources provided by the light source assembly 5 into a surface light source directed toward the columnar structure 1 of the light guide column.

In some embodiments, an outer diameter of the diffusing plate 6 matches an outer diameter of the first housing 41. One end of the first housing 41 abuts against one side of the diffusing plate 6. The other side of the diffusing plate 6 fits against the bottom surface 11a of the second accommodation space 11 (e.g., the upper bottom surface of the second accommodation space 11 shown in FIG. 5 and FIG. 6).

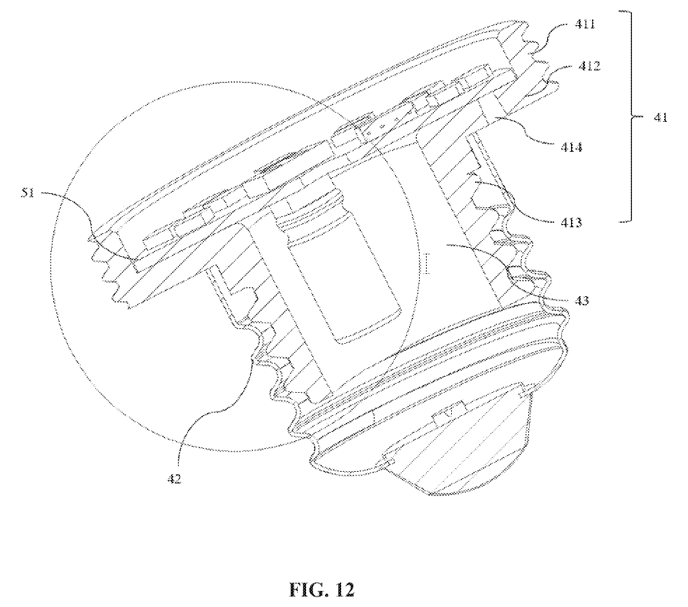

In one or more embodiments of the present disclosure, as shown in FIG. 12, a heat dissipation hole 414 is provided on the second annular structure 412. In some embodiments, a plurality of heat dissipation holes 414 may be provided on the second annular structure 412. The plurality of heat dissipation holes 414 are arranged in a ring array. In some embodiments, the heat dissipation hole 414 may be arc-shaped or kidney-shaped. In some embodiments, the heat dissipation hole 414 is configured to dissipate heat from the circuit board.

In one or more embodiments of the present disclosure, a luminaire including the light guide column may be a wall luminaire, e.g., a fixed wall lamp, a detachable wall lamp, a portable wall lamp with a plug. In some embodiments, the luminaire including the light guide column may also be in various forms, such as a ceiling lamp, a pendant lamp, a floor lamp, or a desk lamp. In some embodiments, the luminaire including the light guide column may be arranged indoors, outdoors, or inside a movable vehicle. In some embodiments, in a usage scenario, the light guide column of the luminaire may be arranged horizontally, vertically, or obliquely. In some embodiments, the luminaire may include one light guide column or a plurality of light guide columns.

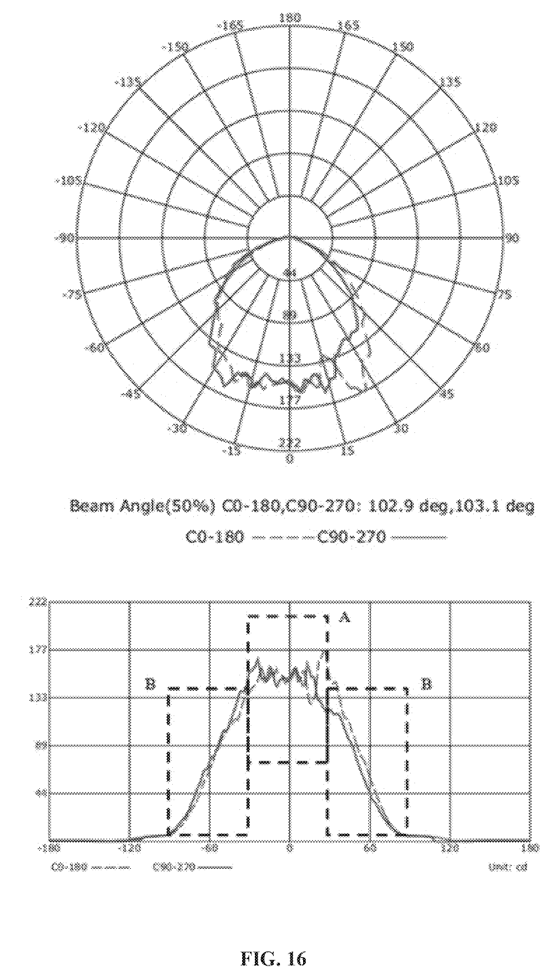

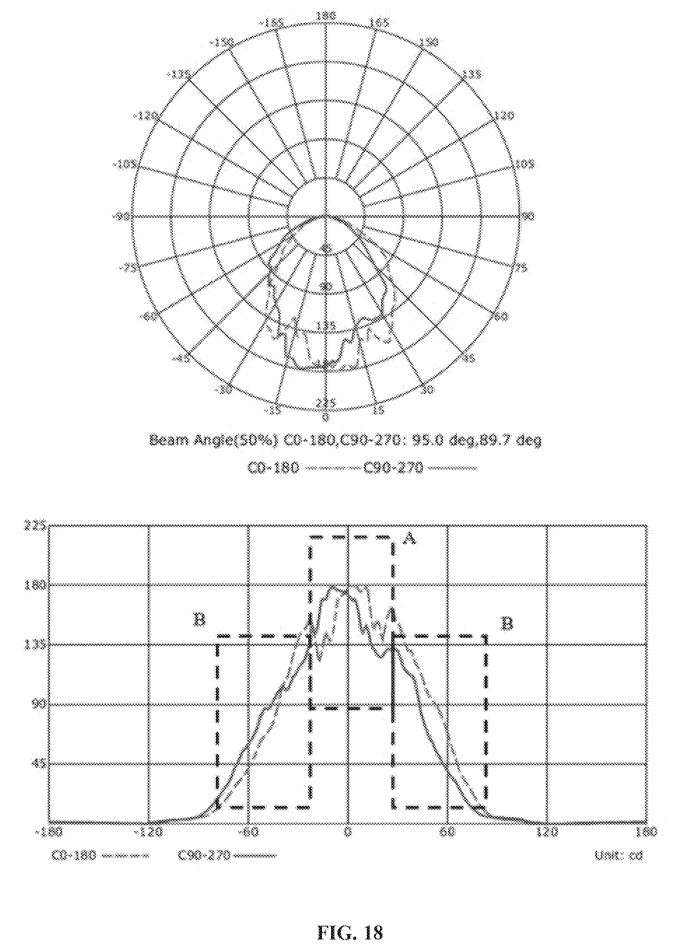

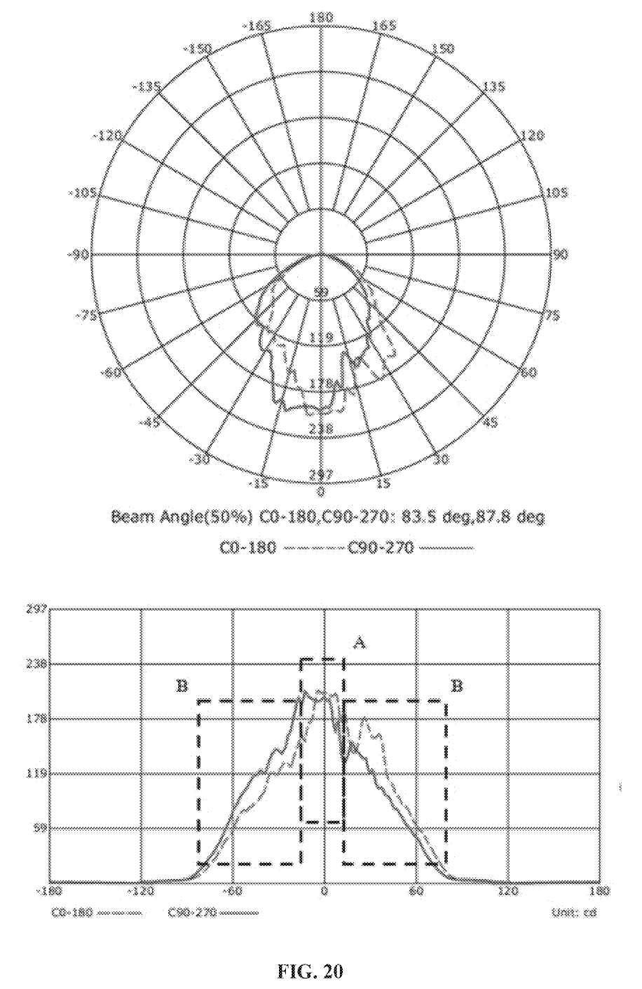

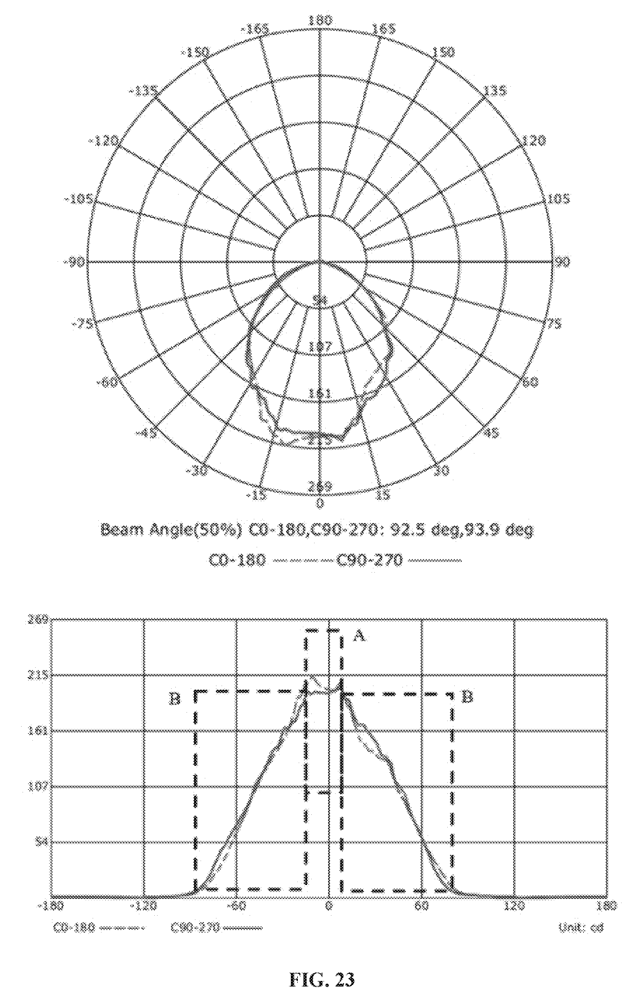

In one or more embodiments of the present disclosure, the light guide column has a luminous intensity distribution curve. FIG. 16, FIG. 18, FIG. 20, and FIG. 23 are schematic diagrams of luminous intensity distribution curves of a light guide column according to some different embodiments of the present disclosure. As shown in FIG. 16, FIG. 18, FIG. 20, and FIG. 23, in some embodiments, at least a portion of the luminous intensity distribution curve of the light guide column exhibits a serrated pattern (or has a serrated structure).

A luminous intensity distribution curve is a distribution graph, represented in a polar coordinate system or a Cartesian coordinate system, of the luminous intensity (unit: candela, cd) of a light source (or a luminaire) in different spatial directions. A luminous intensity distribution curve is a function image (I(θ,ϕ)) of the luminous intensity of a light source varying with spatial angles.

In the embodiments, as shown in FIG. 16, FIG. 18, FIG. 20, and FIG. 23, the interior of the columnar structure 1 of the light guide column includes, from the center to the outer portion, one second region 22, one first annular region 21, and another second region 22. The left diagrams in FIG. 16, FIG. 18, FIG. 20, and FIG. 23 show distribution graphs of the luminous intensity distribution curve in a polar coordinate system, where the polar angle coordinate represents the spatial distribution and the radial distance represents the luminous intensity. The right diagrams in FIG. 16, FIG. 18, FIG. 20, and FIG. 23 show distribution graphs of the luminous intensity distribution curve in a Cartesian coordinate system, where the abscissa represents the spatial distribution and the ordinate represents the luminous intensity.

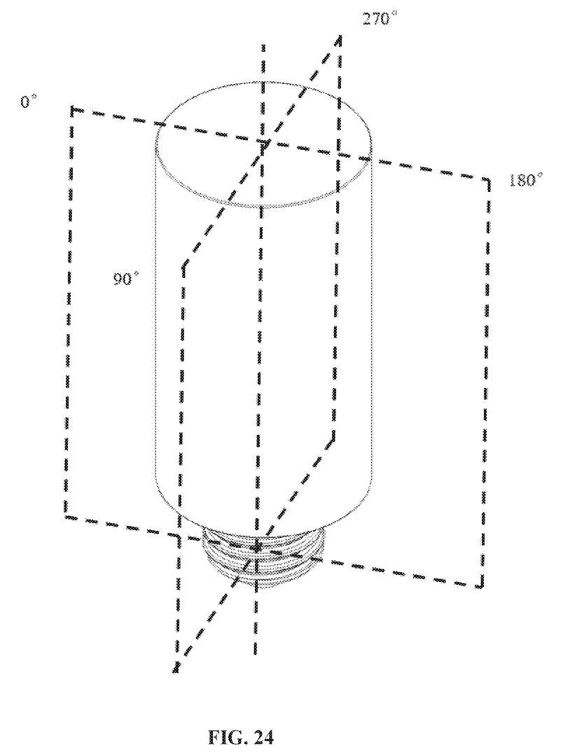

Each distribution graph in FIG. 16, FIG. 18, FIG. 20, and FIG. 23 shows two luminous intensity distribution curves. The two luminous intensity distribution curves represent luminous intensity distribution curves in two different measurement planes (C-Planes), respectively. A measurement plane is a vertical plane passing through a light emission center of the luminaire and a reference axis (e.g., a vertical axis). In one or more embodiments of the present disclosure, the measurement plane is a vertical plane passing through a central axis of the columnar structure 1 of the light guide column and a reference axis perpendicular to the central axis. In some embodiments, the measurement plane may include two planes, which are used to represent the light intensity distributions of the light guide column in two directions. In some embodiments, the two measurement planes may be arranged perpendicularly. As shown in FIG. 24, an example of measurement planes for the luminous intensity distribution curves is shown, which includes a C0°-C180° measurement plane (corresponding to the C0-180 luminous intensity distribution curve in FIG. 16, FIG. 18, FIG. 20, and FIG. 23) and a C90°-C270° measurement plane (corresponding to the C90-270 luminous intensity distribution curve in FIG. 16, FIG. 18, FIG. 20, and FIG. 23).

In some embodiments, as shown in FIG. 16, FIG. 18, FIG. 20, and FIG. 23, at least a portion of the C0-180 luminous intensity distribution curve of the light guide column exhibits the serrated pattern (or has a serrated structure). In some embodiments, at least a portion of the C90-270 luminous intensity distribution curve of the light guide column exhibits the serrated pattern (or has a serrated structure).

In some embodiments, the luminous intensity distribution curve of the light guide column includes a first intensity distribution region A and two second intensity distribution regions B located on both sides of the first intensity distribution region A.

In some embodiments, the luminous intensity distribution curve in the first intensity distribution region A exhibits a transverse trend. In some embodiments, the luminous intensity distribution curve in each of the two second intensity distribution regions B exhibits an increasing trend or a decreasing trend.

In some embodiments, at least one of the luminous intensity distribution curve in the first intensity distribution region A and the luminous intensity distribution curve in the each of the two second intensity distribution regions B exhibits the serrated pattern. In some embodiments, the luminous intensity distribution curve in the first intensity distribution region A exhibits the serrated pattern. In some embodiments, a portion of the luminous intensity distribution curve in the first intensity distribution region A exhibits the serrated pattern. In some embodiments, the entire luminous intensity distribution curve in the first intensity distribution region A exhibits the serrated pattern. In some embodiments, the luminous intensity distribution curve in the each of the two second intensity distribution regions B exhibits the serrated pattern.

In some embodiments, at least a portion of the luminous intensity distribution curve in the first intensity distribution region A and the luminous intensity distribution curve in the each of the two second intensity distribution regions B exhibits the serrated pattern (or has a serrated structure). In some embodiments, the luminous intensity distribution curve in the each of the two second intensity distribution regions B includes a smooth section exhibiting a smooth shape and a serrated section exhibiting the serrated pattern. The serrated section is adjacent to the first intensity distribution region. In some embodiments, as shown in FIG. 16, FIG. 18, FIG. 20, and FIG. 23, a smooth section is formed on a left side of the second intensity distribution region B having an increasing trend, and a serrated section is formed on a right side of the second intensity distribution region B having an increasing trend; a serrated section is formed on a left side of the second intensity distribution region B having a decreasing trend, and a smooth section is formed on a right side of the second intensity distribution region B having a decreasing trend.

In some embodiments, the aforementioned serrated pattern or serrated section refers to the luminous intensity distribution curve being composed of linear segments (e.g., straight line segments or curved segments). In some embodiments, these straight line segments or curved segments are connected at acute angles, forming a periodic pattern of "rise-fall" or "rise-reset".

In some embodiments, the serrated pattern or serrated section refers to a luminous intensity distribution curve having periodic or non-periodic turning points.

In some embodiments, the serrated pattern or serrated section refers to a luminous intensity distribution curve that is continuous (without discontinuity points) but not differentiable (the derivative is discontinuous or does not exist at the turning points).

Merely by way of example, at least a portion of the luminous intensity distribution curve of the light guide column includes straight line segments and/or curved segments connected at acute angles, and adjacent straight line segments and/or curved segments form turning points (e.g., sharp turning points). Merely by way of example, at least a portion of the luminous intensity distribution curve of the light guide column includes a plurality of turning points, and the luminous intensity distribution curve of the light guide column is not differentiable at the turning points.

In some related embodiments, the luminous intensity distribution curve of the luminaire is smooth without abrupt changes, and the illumination is uniform. In one or more embodiments of the present disclosure, the luminous intensity distribution curve of the luminaire has abrupt changes and has a plurality of consecutive abrupt changes, so that the illumination has stripes with alternating bright and dark areas, such as a water ripple pattern with alternating bright and dark areas, in a small-size range under the condition of having a certain uniformity in a large-size range, thereby forming a good visual effect while ensuring illumination.

In some embodiments, the serrated pattern of the luminous intensity distribution curve (e.g., the serrated structure in the first intensity distribution region A and/or the serrated structure in the second intensity distribution region B) may be formed by refraction of light at the bubbles 3. In some embodiments, the light guide column includes a light incident surface (e.g., a bottom surface of the columnar structure 1 in FIG. 1) and a light-emitting surface. In some embodiments, the light guide column includes a first light-emitting surface 1a and a second light-emitting surface 1b. The first light-emitting surface 1a is provided by at least a portion of an outer circumferential surface of the columnar structure 1 (e.g., a side surface of the columnar structure 1 in FIG. 1. The second light-emitting surface 1b is provided by at least a portion of an end surface of one end of the columnar structure 1 (e.g., a top surface of the columnar structure 1 in FIG. 1). In some embodiments, the light incident surface is a flat surface. In some embodiments, the second light-emitting surface 1b is a flat surface.

In some embodiments, light enters the interior of the columnar structure 1 from the light incident surface. In some embodiments, light may enter the interior of the columnar structure 1 at an angle perpendicular to the light incident surface. In some embodiments, the light may be parallel light. In some embodiments, after light enters the interior of the columnar structure 1, a first refraction occurs at an interface between the columnar structure 1 and a bubble 3, and the light enters an interior of the bubble 3. In some embodiments, after light enters the interior of the bubble 3, reflection occurs at the interface between the bubble 3 and the columnar structure 1 (e.g., at an inner wall of the bubble 3). After light enters the interior of a bubble 3, a second refraction occurs at the interface between the bubble 3 and the columnar structure 1, the light exits the bubble 3 and enters a solid portion of the columnar structure 1, and further enters another bubble 3, or exits the columnar structure 1 from the first light-emitting surface 1a or the second light-emitting surface 1b.

In some embodiments, light can undergo a plurality of reflections within the interior of the same bubble 3. In some embodiments, light can undergo a plurality of refractions at different bubbles 3. In some embodiments, light can enter a first bubble 3, then enter a second bubble 3, and then return to the first bubble 3.

In the above embodiments, reflection of light inside the bubble 3 enables the light to exit from various points at the inner wall of the bubble 3, thereby illuminating the bubble 3 and allowing a user to observe the illuminated bubble 3 inside the transparent columnar structure 1 from the outer portion of the columnar structure 1. In the above embodiments, the plurality of reflections allow light to refract out from different positions and angles of the bubble 3.

In the above embodiments, after light is refracted within one or more bubbles 3, the light can exit from the first light-emitting surface 1a located on the side, and can also exit from the second light-emitting surface 1b located at the end, thereby forming peripheral illumination and end illumination, and having an extremely large illumination range. In the above embodiments, when exiting from the first light-emitting surface 1a and/or the second light-emitting surface 1b, due to refraction through one or more bubbles 3, the light superimposes in some areas and reduces in other areas, thereby forming stripes with alternating bright and dark areas, such as water ripple patterns with alternating bright and dark areas.

In one or more embodiments of the present disclosure, an amplitude of serrations in the first intensity distribution region A having the transverse trend is within a first range. In some embodiments, the serrations in the first intensity distribution region A having the transverse trend have the same or substantially the same amplitude, so that the formed stripes with alternating bright and dark areas still have a suitable illumination effect in the relatively dark parts. In some embodiments, a minimum amplitude of the serrations in the first intensity distribution region A having the transverse trend may be 8-12% of a maximum amplitude. In some embodiments, the minimum amplitude of the serrations in the first intensity distribution region A having the transverse trend may be 10% of the maximum amplitude.

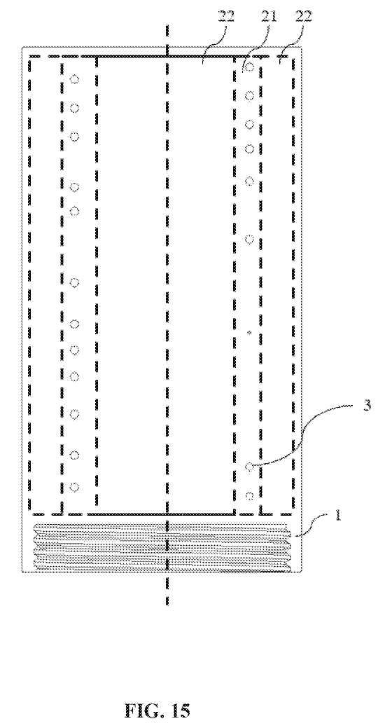

FIG. 15 is a schematic diagram of a light guide column with a single layer of small bubbles in an outer portion according to some embodiments of the present disclosure. FIG. 16 is a schematic diagram of a luminous intensity distribution curve of the light guide column with the single layer of small bubbles in the outer portion shown in FIG. 15. As shown in FIG. 15 and FIG. 16, in one or more embodiments of the present disclosure, the light guide column may have the single layer of small bubbles in the outer portion. In some embodiments, the light guide column can include a first annular region 21. The first annular region 21 may include bubbles 3 with a small diameter. In some embodiments, a count of the first annular region 21 is one. An inner diameter of the first annular region 21 is greater than or equal to half of a diameter of the columnar structure 1. In some embodiments, the light guide column can sequentially include, from a center to a periphery, a second region 22 located at the center, a first annular region 21 located in a middle portion, and a second region 22 located at the periphery. In some embodiments, a diameter of the columnar structure 1 of the light guide column may be 50±5 mm. In some embodiments, a diameter of the second region 22 located at the center may be about 26±2 mm, a ring width of the first annular region 21 located in the middle portion may be 1.5-2 mm (e.g., equivalent to a width of one bubble 3), and a ring width of the second region 22 located at the periphery may be 10±1 mm. In some embodiments, the diameter of the columnar structure 1 of the light guide column may be selected according to equipment requirements. In some embodiments, the ring width of the first annular region 21 of the columnar structure 1 of the light guide column may be adjusted according to the diameter of the bubble 3. In some embodiments, the diameter or the ring width of the second region 22 of the columnar structure 1 of the light guide column may be adjusted based on the ring width of the first annular region 21, a position of the first annular region 21 inside the columnar structure 1, a light emission effect of the light guide column, etc.

In some embodiments, a diameter of the bubble 3 is 1.5-2 mm. For example, the diameter of the bubble 3 may be 1.5 mm, 1.6 mm, 1.75 mm, 1.8 mm, 1.86 mm, 1.9 mm, 1.965 mm, and/or 2.0 mm. In some embodiments, a maximum spacing between adjacent bubbles 3 is selected from a range of 10-15 mm. For example, the maximum spacing between adjacent bubbles 3 may be selected from 10 mm, 11 mm, 12.5 mm, 13.6 mm, 14 mm, or 15 mm. In some embodiments, as a result of process precision, a majority of the bubbles 3 (e.g., more than 90% by count) have a diameter in the range of 1.5-2 mm, and a small count of cavities or bubbles whose diameters fall outside the range of 1.5-2 mm may still be present.

In some embodiments, adjacent bubbles 3 refer to two bubbles 3 in the same first annular region 21 that are closest to each other in physical space, and no other bubble 3 is closer to either of the two bubbles 3. In some embodiments, a maximum spacing refers to a spacing between two adjacent bubbles 3 having the largest spacing among all bubbles 3 inside the same first annular region 21. It should be understood that a spacing between two adjacent bubbles 3 inside the same first annular region 21 may be less than the maximum spacing. In some embodiments, a spacing between bubbles 3 refers to a shortest spatial distance from a surface of one bubble 3 to a surface of another bubble 3.

In some embodiments, the light guide column has a single layer of bubbles 3, and the bubbles 3 have a relatively small size and a relatively sparse distribution spacing.

In some embodiments, as shown in FIG. 16, the luminous intensity distribution curve of the light guide column having the single layer of small bubbles in the outer portion includes a first intensity distribution region A and two second intensity distribution regions B located on two sides of the first intensity distribution region A. In some embodiments, the luminous intensity distribution curve in the first intensity distribution region A exhibits a transverse trend. Merely by way of example, the first intensity distribution region A having the transverse trend is formed within an azimuth angle range of approximately -30° to +30° in FIG. 16. In some embodiments, the luminous intensity distribution curve in each of the two second intensity distribution regions B exhibits an increasing trend or a decreasing trend. Merely by way of example, the second intensity distribution region B having the increasing trend is formed within an azimuth angle range of approximately -90° to -30° in FIG. 16, and the second intensity distribution region B having the decreasing trend is formed within an azimuth angle range of approximately +30° to +90° in FIG. 16.

In some embodiments, as shown in FIG. 16, a 50% beam angle of the light guide column is greater than 100°, which provides an extremely wide illumination angle suitable for large-area illumination and capable of covering an entire space. Merely by way of example, a beam angle of the light guide column in a C0°-C180° measurement plane is 102.9°. Merely by way of example, a beam angle of the light guide column in a C90°-C270° measurement plane is 103.1°. In some embodiments, the 50% beam angle is also referred to as a full width at half maximum beam angle. The 50% beam angle refers to an angle formed by light rays on two sides when a light intensity drops to 50% of a maximum central value, with a central optical axis of a luminaire (e.g., a light guide column equipped with a light source) as a reference.

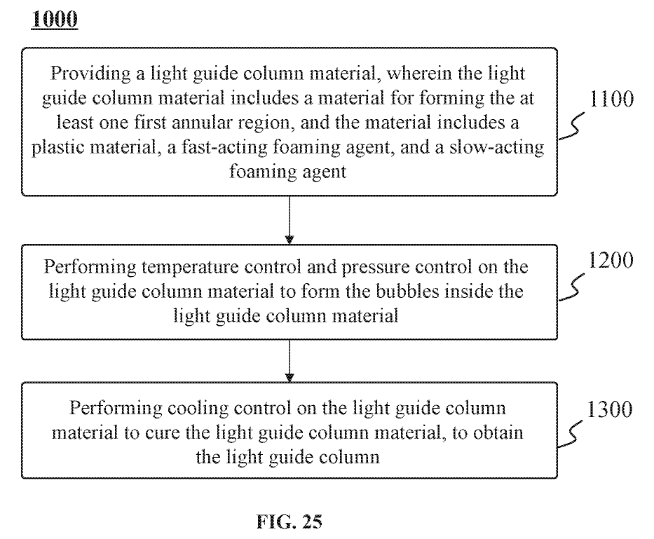

FIG. 25 is an exemplary flowchart illustrating a process for manufacturing a light guide column according to some embodiments of the present disclosure. As shown in FIG. 25, in some embodiments, a process 1000 is applicable to manufacturing a light guide column. The light guide column includes a columnar structure 1. The columnar structure 1 is made of a transparent material. An interior of the columnar structure 1 includes at least one first annular region 21 centered on an axis of the columnar structure 1, and an interior of the at least one first annular region 21 has bubbles 3. At least a portion of a luminous intensity distribution curve of the light guide column has a serrated pattern. In some embodiments, the process 1000 may be applicable to manufacturing the aforementioned light guide column having the single layer of small bubbles in the outer portion. In some embodiments, the process 1000 may include steps 1100-1300.

Step 1100, providing a light guide column material. The light guide column material includes a material for forming the at least one first annular region 21, and the material includes a plastic material, a fast-acting foaming agent, and a slow-acting foaming agent.

Step 1200, performing temperature control and pressure control on the light guide column material to form the bubbles inside the light guide column material.

Step 1300, performing cooling control on the light guide column material to cure the light guide column material, to obtain the light guide column.

In some embodiments, the fast-acting foaming agent may react rapidly and produce a large amount of gas within its effective decomposition temperature range, thereby forming bubbles 3 or supplementing gas inside bubbles 3. In some embodiments, the fast-acting foaming agent may react to produce a small amount of gas within a certain temperature range below the effective decomposition temperature range. For example, undergoing a pre-decomposition reaction, the fast-acting foaming agent may produce gas. In some embodiments, the fast-acting foaming agent may decompose violently when the temperature is slightly above the effective decomposition temperature range. In some embodiments, the fast-acting foaming agent may slow down and eventually stop reacting completely within a certain temperature range far above the effective decomposition temperature range.

In some embodiments, the slow-acting foaming agent may react continuously and stably to produce gas within its effective decomposition temperature range, thereby forming bubbles 3 or supplementing gas inside bubbles 3. In some embodiments, the slow-acting foaming agent may react to produce a small amount of gas within a certain temperature range below the effective decomposition temperature range. For example, undergoing a pre-decomposition reaction, the slow-acting foaming agent may produce gas. In some embodiments, the slow-acting foaming agent may gradually slow down and eventually stop reacting completely within a certain temperature range above the effective decomposition temperature range.

In some embodiments, the effective decomposition temperature range includes a lowest effective decomposition temperature and a highest effective decomposition temperature. In some embodiments, the effective decomposition temperature range refers to a temperature range including the lowest effective decomposition temperature and the highest effective decomposition temperature. In some embodiments, when a temperature is between the lowest effective decomposition temperature and the highest effective decomposition temperature, the foaming agent may decompose stably and controllably and release gas. In some embodiments, within the effective decomposition temperature range, the foaming agent may begin to decompose and may be substantially completely decomposed, and a decomposition rate is relatively stable.

In some embodiments, when a temperature is below the effective decomposition temperature range, the foaming agent may be in a state of no decomposition or only a small amount of decomposition, and an amount of gas produced is insufficient. In some embodiments, when a temperature is slightly above the effective decomposition temperature range, the foaming agent may decompose violently within an extremely short time, releasing a large amount of gas. In some embodiments, when a temperature is far above the effective decomposition temperature range, the foaming agent may slow down and eventually stop reacting completely.

In some embodiments, the effective decomposition temperature range of the fast-acting foaming agent partially overlaps the effective decomposition temperature range of the slow-acting foaming agent. In some embodiments, a lowest effective decomposition temperature of the fast-acting foaming agent is lower than a highest effective decomposition temperature of the slow-acting foaming agent, and a highest effective decomposition temperature of the fast-acting foaming agent is higher than the highest effective decomposition temperature of the slow-acting foaming agent. In some embodiments, a lowest effective decomposition temperature of the slow-acting foaming agent is lower than the lowest effective decomposition temperature of the fast-acting foaming agent, and the highest effective decomposition temperature of the slow-acting foaming agent is higher than the lowest effective decomposition temperature of the fast-acting foaming agent.

In some embodiments, the effective decomposition temperature ranges of the fast-acting foaming agent and the slow-acting foaming agent are configured to have overlapping parts and non-overlapping parts. In some embodiments, the above configuration enables a user to independently control the reaction progress of the fast-acting foaming agent and the slow-acting foaming agent through temperature during the gradual heating process, thereby controlling the amount of gas generated by the fast-acting foaming agent and the amount of gas generated by the slow-acting foaming agent, and further controlling the size of each of the bubbles 3.

In some embodiments, the fast-acting foaming agent is an azodicarbonamide foaming agent (ACA foaming agent), and an effective decomposition temperature range of the azodicarbonamide foaming agent is 195-220°C.

In some embodiments, the slow-acting foaming agent is a sodium bicarbonate-citric acid foaming agent (sodium bicarbonate foaming agent compounded with citric acid), and an effective decomposition temperature range of the sodium bicarbonate-citric acid foaming agent is 160-200°C. In some embodiments, the effective decomposition temperature range of the sodium bicarbonate-citric acid foaming agent may be adjusted by adjusting the content of citric acid in the sodium bicarbonate-citric acid foaming agent. In some embodiments, increasing the content of citric acid in the sodium bicarbonate-citric acid foaming agent may lower the effective decomposition temperature range. For example, the lowest effective decomposition temperature of the sodium bicarbonate-citric acid foaming agent may be reduced to 140°C to 160°C, or the like.

In one or more embodiments of the present disclosure, the light guide column may include one layer of bubbles. In some embodiments, the interior of the columnar structure 1 of the light guide column includes a first annular region 21 and two second regions 22 centered on the axis of the columnar structure 1. The first annular region 21 has the bubbles 3 therein. A diameter of each of the bubbles 3 of the light guide column is in a range of 1.5-2 mm, and a maximum spacing between adjacent bubbles 3 is selected from a range of 10-15 mm. In some embodiments, as a result of process precision, a majority of the bubbles 3 within the first annular region 21 (e.g., more than 90% by count) have a diameter in the range of 1.5-2 mm, and a small count of cavities or bubbles whose diameters fall outside the range of 1.5-2 mm may still be present within the first annular region 21.

In some embodiments, step 1100 may include: providing the light guide column material, the light guide column material including a first material for forming a second region 22 located on an inner portion, a second material for forming the first annular region 21 located in a middle portion, and a third material for forming a second region 22 located on an outer portion. Each of the first material and the third material include the plastic material, and the second material includes the plastic material, the fast-acting foaming agent, and the slow-acting foaming agent.

In some embodiments, the second material includes, by mass parts: 98.8-99.5 parts of the plastic material, 0.2-0.4 parts of the fast-acting foaming agent, and 0.8-1 part of the slow-acting foaming agent. Merely by way of example, the second material may include, by mass parts: 98.8 parts of the plastic material, 0.3 parts of the fast-acting foaming agent, and 0.9 parts of the slow-acting foaming agent. For example, the 0.3 parts of the fast-acting foaming agent may include 0.3 parts of the azodicarbonamide foaming agent; the 0.9 parts of the slow-acting foaming agent may include 0.7 parts of sodium bicarbonate compounded with 0.2 parts of citric acid.

In some embodiments, step 1200 may include: causing the light guide column material to be at a first temperature and a first pressure, to melt the plastic material while avoiding decomposition of the fast-acting foaming agent and the slow-acting foaming agent. In some embodiments, the first temperature is 160±1°C (e.g., 160°C), and the first pressure is 1.2±0.1 MPa (e.g., 1.2 MPa). In some embodiments, the first pressure enables stable conveying of the light guide column material in the molten state, and foaming of the fast-acting foaming agent and the slow-acting foaming agent is better suppressed.

In some embodiments, step 1200 may include: causing the light guide column material to be at a second temperature and a second pressure, to initiate decomposition of the slow-acting foaming agent. The second temperature is within the effective decomposition temperature range of the slow-acting foaming agent, the second temperature is lower than the lowest effective decomposition temperature of the fast-acting foaming agent, and the second pressure is lower than the first pressure. In some embodiments, the second temperature may be 180±1°C (e.g., 180°C). In some embodiments, at the second temperature, the slow-acting foaming agent begins to decompose and generates small bubbles. In some embodiments, the second pressure may be 0.9±0.1 MPa (e.g., 0.9 MPa). In some embodiments, a moderate second pressure promotes uniform dispersion of the sodium bicarbonate within the plastic material and restricts premature expansion of the small bubbles formed by the sodium bicarbonate.

In some embodiments, step 1200 may include: causing the light guide column material to be at a third temperature and a third pressure, to initiate decomposition of the fast-acting foaming agent. The third temperature is within the effective decomposition temperature range of the slow-acting foaming agent and the effective decomposition temperature range of the fast-acting foaming agent, and the third pressure is lower than the second pressure. In some embodiments, the third temperature is 195±1°C (e.g., 195°C). In some embodiments, at the third temperature, the slow-acting foaming agent continues to decompose, and the fast-acting foaming agent decomposes in trace amounts to supplement gas. In some embodiments, at the third temperature, the decomposition amount of the fast-acting foaming agent is less than 10%. In some embodiments, the third pressure is 0.6±0.1 MPa (e.g., 0.6 MPa). In some embodiments, the lower third pressure allows the small bubbles to grow slowly, and the fast-acting foaming agent provides trace gas to fill voids.

In some embodiments, step 1200 may include: causing the light guide column material to be at a fourth temperature and a fourth pressure, to reduce or suppress decomposition of the fast-acting foaming agent. The fourth temperature is lower than the lowest effective decomposition temperature of the fast-acting foaming agent, the fourth pressure includes a peripheral pressure and a central pressure, and the peripheral pressure is greater than the central pressure. In some embodiments, the fourth temperature is 170±1°C (e.g., 170°C). In some embodiments, at the fourth temperature, decomposition of the fast-acting foaming agent is inhibited, thereby seting the size of the bubbles 3. In some embodiments, the peripheral pressure of the fourth pressure is 1.5±0.1 MPa (e.g., 1.5 MPa). In some embodiments, the central pressure of the fourth pressure is 0.6±0.1 MPa (e.g., 0.6 MPa). In some embodiments, the high peripheral pressure may compress the bubbles 3, causing the bubbles 3 to migrate inward. The low central pressure enables uniform arrangement of the bubbles 3 and refines the distribution of the bubbles 3.

In some embodiments, step 1300 may include: performing pre-cooling on the light guide column material. In some embodiments, the pre-cooling may include air cooling. In some embodiments, the cooling temperature for the air cooling may be 35°C, and the air speed may be 1.5 m/s. In some embodiments, the cooling rate for the pre-cooling may be 0.8° C/s. In some embodiments, the light guide column material is cooled down slowly and uniformly during the pre-cooling process to prevent bubble contraction.

In some embodiments, step 1300 may include: performing main cooling on the light guide column material. In some embodiments, the main cooling may include cooling in a warm water tank. In some embodiments, the cooling temperature of the warm water tank may be 60°C, and a flow rate of the warm water tank may be 5 L/min. In some embodiments, a cooling rate of the main cooling is greater than a cooling rate of the pre-cooling. In some embodiments, the cooling rate of the main cooling may be 3 times or greater than the cooling rate of the pre-cooling. In some embodiments, the cooling rate of the main cooling may be 2.5 °C/s. In some embodiments, the outer wall of the material solidifies at a medium rate during the main cooling, thereby locking the distribution of the small bubbles.

In some embodiments, step 1300 may include: performing final cooling on the light guide column material. In some embodiments, the final cooling may include ice water spraying. In some embodiments, a spraying temperature of the ice water spraying may be 5°C, and the spraying pressure may be 0.25 MPa. In some embodiments, a cooling rate of the final cooling is greater than the cooling rate of the main cooling. In some embodiments, the cooling rate of the final cooling may be 1.5 to 2 times the cooling rate of the main cooling. In some embodiments, the cooling rate of the final cooling may be 4 °C/s. In some embodiments, the final cooling process rapidly terminates the reaction, thereby preventing deformation at a later stage.

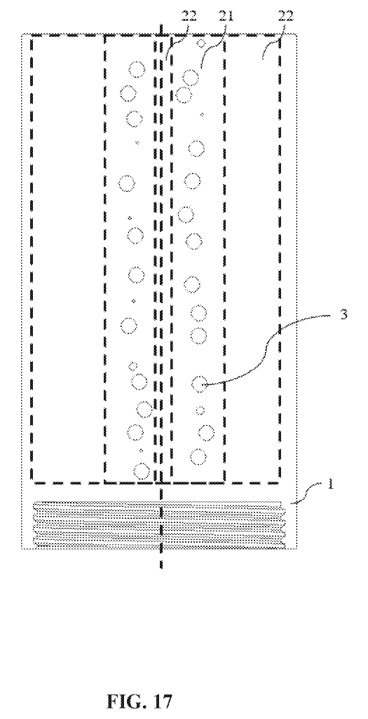

FIG. 17 is a schematic diagram illustrating a light guide column with a single layer of medium bubbles in a middle part according to some embodiments of the present disclosure; FIG. 18 is a schematic diagram illustrating a luminous intensity distribution curve of the light guide column with the single layer of medium bubbles in the middle part shown in FIG. 17. As shown in FIG. 17 and FIG. 18, in some embodiments of the present disclosure, the light guide column may have the single layer of medium bubbles in the middle part. In some embodiments, the light guide column may include a first annular region 21. The first annular region 21 may include bubbles 3 with a medium-sized diameter. In some embodiments, a count of the at least one first annular region 21 is one, and an outer diameter of the first annular region 21 is less than or equal to half of a diameter of the columnar structure 1.

In some embodiments, the light guide column may sequentially include, from a center to a periphery, a second region 22 located at the center, the first annular region 21 located in a middle portion, and a second region 22 located at the periphery. In some embodiments, the diameter of the columnar structure 1 of the light guide column may be 50±5 mm. In some embodiments, a diameter of the second region 22 located at the center may be about 10±2 mm. A ring width of the first annular region 21 located in the middle portion may be about 3-4 mm (e.g., equivalent to a width of one bubble 3). A ring width of the second region 22 located at the periphery may be about 16±1 mm.

In some embodiments, a diameter of each of the bubbles 3 is in a range of 3 to 4 mm. For example, the diameter of each of the bubbles 3 may be 3.1 mm, 3.25 mm, 3.3 mm, 3.4 mm, 3.485 mm, 3.6 mm, 3.862 mm, or 4.0 mm. In some embodiments, a maximum spacing between adjacent bubbles 3 is selected from a range of 8 to 10 mm. For example, the maximum spacing between adjacent bubbles 3 may be selected from 8 mm, 8.5 mm, 8.8 mm, 9 mm, 9.65 mm, or 10 mm. In some embodiments, as a result of process precision, a majority of the bubbles 3 (e.g., more than 90% by count) have a diameter in the range of 3-4 mm, and a small count of cavities or bubbles whose diameters fall outside the range of 3-4 mm may still be present.

In some embodiments, the light guide column has a single layer of bubbles 3. The bubbles 3 have a medium size and a medium distribution spacing.

In some embodiments, as shown in FIG. 18, the luminous intensity distribution curve of the light guide column includes a first intensity distribution region A and two second intensity distribution regions B located on both sides of the first intensity distribution region A. In some embodiments, the luminous intensity distribution curve in the first intensity distribution region A has a transverse trend. For example, the first intensity distribution region A with the transverse trend is formed within an azimuth angle range of approximately -15° to +15° in FIG. 18. In some embodiments, the luminous intensity distribution curve in each of the two second intensity distribution regions B has an increasing trend or a decreasing trend. For example, the second intensity distribution region B with the increasing trend is formed within an azimuth angle range of approximately -90° to -15° in FIG. 18. The second intensity distribution region B with the decreasing trend is formed within an azimuth angle range of approximately +15° to +90° in FIG. 18.

In some embodiments, as shown in FIG. 18, a 50% beam angle of the light guide column is in a range of 85 to 95°. The light guide column has a large illumination angle, is suitable for wide-area illumination, and can cover an entire space. For example, a beam angle of the light guide column on a C0°-C180° measurement plane is 95.0°. As another example, a beam angle of the light guide column on a C90°-C270° measurement plane is 89.7°. In some embodiments, the 50% beam angle also refers to as a full width at half maximum beam angle. The 50% beam angle refers to an angle formed by light rays on two sides when a light intensity drops to 50% of a maximum central value, with a central optical axis of the luminaire (e.g., the light guide column assembled with a light source) as a reference.

In some embodiments of the present disclosure, as shown in FIG. 25, process 1000 may be applicable to manufacturing the aforementioned light guide column with the single layer of medium bubbles in the middle part. In some embodiments, the light guide column may include one layer of bubbles. In some embodiments, the interior of the columnar structure 1 of the light guide column includes a first annular region 21 and two second regions 22 centered on the axis of the columnar structure 1. The first annular region 21 includes bubbles 3. A diameter of each of the bubbles 3 of the light guide column is in a range of 3-4 mm, and a maximum spacing between adjacent bubbles 3 is selected from a range of 8-10 mm. In some embodiments, as a result of process precision, a majority of the bubbles 3 within the first annular region 21 (e.g., more than 90% by count) have a diameter in the range of 3-4 mm, and a small count of cavities or bubbles whose diameters fall outside the range of 3-4 mm may still be present within the first annular region 21.

In some embodiments, step 1100 may further include: providing the light guide column material, the light guide column material including a first material for forming a second region 22 located on an inner portion, a second material for forming the first annular region 21 located in a middle portion, and a third material for forming a second region 22 located on an outer portion. Each of the first material and the third material include the plastic material, and the second material includes the plastic material, the fast-acting foaming agent, and the slow-acting foaming agent.

In some embodiments, the second material includes, by mass parts: 97.8-98.7 parts of the plastic material, 0.5-0.7 parts of the fast-acting foaming agent, and 0.5-0.7 parts of the slow-acting foaming agent. Merely by way of example, the second material may include, by mass parts: 98.5 parts of the plastic material, 0.6 parts of the fast-acting foaming agent, and 0.6 parts of the slow-acting foaming agent. For example, the 0.6 parts of the fast-acting foaming agent may include 0.6 parts of an azodicarbonamide foaming agent; the 0.6 parts of the slow-acting foaming agent may include 0.4 parts of sodium bicarbonate compounded with 0.2 parts of citric acid.

In some embodiments, step 1200 may include: causing the light guide column material to be at a first temperature and a first pressure, to melt the plastic material while avoiding decomposition of the fast-acting foaming agent and the slow-acting foaming agent. In some embodiments, the first temperature is 170±1°C (e.g., 170°C), and the first pressure is 1.3±0.1 MPa (e.g., 1.3MPa). In some embodiments, under a slightly higher first pressure, the molten light guide column material, which is more viscous, can be conveyed relatively stably. Furthermore, foaming of the fast-acting foaming agent and the slow-acting foaming agent is better suppressed.

In some embodiments, step 1200 may include: causing the light guide column material to be at a second temperature and a second pressure, to initiate decomposition of the slow-acting foaming agent. The second temperature is within the effective decomposition temperature range of the slow-acting foaming agent. The second temperature is lower than the lowest effective decomposition temperature of the fast-acting foaming agent, and the second pressure is lower than the first pressure. In some embodiments, the second temperature is 200±1°C (e.g., 200°C). In some embodiments, at the second temperature, the slow-acting foaming agent begins to decompose and generates small bubbles. In some embodiments, the second pressure is 0.8±0.1 MPa (e.g., 0.8 MPa). In some embodiments, the second pressure, which is reduced relative to the first pressure, can promote gas nucleation but suppress premature expansion of the small bubbles.

In some embodiments, step 1200 may include: causing the light guide column material to be at a third temperature and a third pressure, to initiate decomposition of the fast-acting foaming agent. The third temperature is within the effective decomposition temperature range of the slow-acting foaming agent and the effective decomposition temperature range of the fast-acting foaming agent, and the third pressure is lower than the second pressure. In some embodiments, the third temperature is 215±1°C (e.g., 215°C). In some embodiments, at the third temperature, the fast-acting foaming agent completely decomposes and generates gas. An amount of gas increases to form medium-sized bubbles. In some embodiments, the third pressure is 0.5±0.1 MPa (e.g., 0.5 MPa). In some embodiments, the lower third pressure can accelerate the bubbles to coalesce and reach a diameter of 3-4 mm.

In some embodiments, step 1200 may include: causing the light guide column material to be at a fourth temperature and a fourth pressure, to reduce or suppress decomposition of the fast-acting foaming agent. The fourth temperature is lower than the lowest effective decomposition temperature of the fast-acting foaming agent, the fourth pressure includes a peripheral pressure and a central pressure, and the peripheral pressure is greater than the central pressure. In some embodiments, the fourth temperature is 190±1°C (e.g., 190°C). In some embodiments, at the fourth temperature, moderate cooling can balance the bubbles growth and shaping. In some embodiments, the peripheral pressure of the fourth pressure is 1.5±0.1 MPa (e.g., 1.5 MPa). In some embodiments, the central pressure of the fourth pressure is 0.5±0.1 MPa (e.g., 0.5 MPa). In some embodiments, the high peripheral pressure can compress the bubbles 3, causing the bubbles 3 to migrate inward and limiting diffusion of the bubbles 3, and the low central pressure can maintain growth of the bubbles 3.

In some embodiments, step 1300 may include: performing pre-cooling on the light guide column material. In some embodiments, the pre-cooling may include air cooling. In some embodiments, the cooling temperature for the air cooling may be 45°C, and the air speed may be 2 m/s. In some embodiments, the cooling rate for the pre-cooling may be 1.2 °C/s. In some embodiments, the light guide column material undergoes a moderately accelerated pre-cooling process, thereby restricting excessive growth of the bubbles.

In some embodiments, step 1300 may include: performing main cooling on the light guide column material. In some embodiments, the main cooling may include cooling in a warm water tank. In some embodiments, the cooling temperature of the warm water tank may be 70°C, and the flow rate of the warm water tank may be 6 L/min. In some embodiments, the cooling rate of the main cooling is greater than the cooling rate of the pre-cooling. In some embodiments, the cooling rate of the main cooling may be 2 to 3 times the cooling rate of the pre-cooling. In some embodiments, the cooling rate of the main cooling may be 3 °C/s. In some embodiments, the outer wall of the material undergoes rapid solidification during the main cooling, thereby preventing the diffusion of bubbles.

In some embodiments, step 1300 may include: performing final cooling on the light guide column material. In some embodiments, the final cooling may include ice water spraying. In some embodiments, the spraying temperature of the ice water spraying may be 8°C, and the spraying pressure may be 0.3 MPa. In some embodiments, the cooling rate of the final cooling is greater than the cooling rate of the main cooling. In some embodiments, the cooling rate of the final cooling may be 1.5 to 2 times the cooling rate of the main cooling. In some embodiments, the cooling rate of the final cooling may be 5 °C/s. In some embodiments, the final cooling process rapidly terminates the reaction and locks the structure, thereby preventing later-stage deformation and reducing dimensional variations.

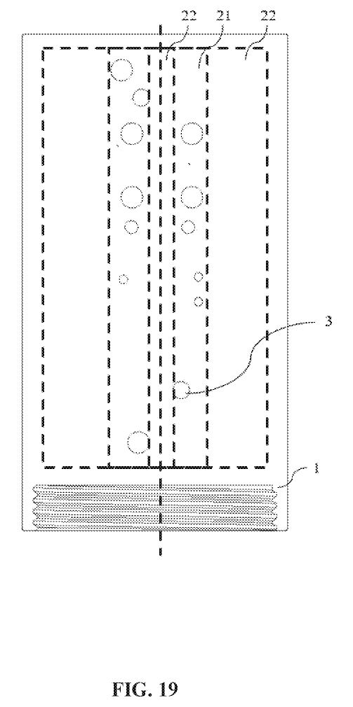

FIG. 19 is a schematic diagram illustrating a light guide column with a single layer of large bubbles in an inner portion according to some embodiments of the present disclosure; FIG. 20 is a schematic diagram illustrating a luminous intensity distribution curve of a light guide column with the single layer of large bubbles in the inner portion shown in FIG. 19. As shown in FIG. 19 and FIG. 20, in some embodiments of the present disclosure, the light guide column may have the single layer of large bubbles in the inner portion (the smaller bubbles shown in FIG. 19 are actually smaller cross-sections of larger bubbles located further back). In some embodiments, the light guide column may include a first annular region 21. The first annular region 21 may include bubbles 3 with a relatively large diameter. In some embodiments, a count of the at least one first annular region 21 is one, and an outer diameter of the first annular region 21 is less than or equal to half of a diameter of the columnar structure 1.

In some embodiments, the light guide column may sequentially include, from a center to a periphery, a second region 22 located at the center, the first annular region 21 located in a middle portion, and a second region 22 located at the periphery. In some embodiments, the diameter of the columnar structure 1 of the light guide column may be 50±5 mm. In some embodiments, a diameter of the second region 22 located at the center may be about 4±2 mm. A ring width of the first annular region 21 located in the middle portion may be about 5-7 mm (e.g., equivalent to a width of one bubble 3). A ring width of the second region 22 located at the periphery may be about 16±1 mm.

In some embodiments, a diameter of each of the bubbles 3 is in a range of 5 to 7 mm. For example, the diameter of each of the bubbles 3 may be 5.1 mm, 5.25 mm, 5.6 mm, 6.0 mm, 6.152 mm, 6.5 mm, 6.85 mm, or 7.0 mm. In some embodiments, a maximum spacing between adjacent bubbles 3 is selected from a range of 3 to 6 mm. For example, the maximum spacing between adjacent bubbles 3 may be selected from 3mm, 3.5mm, 4.8mm, 5mm, 5.65mm, or 6 mm. In some embodiments, as a result of process precision, a majority of the bubbles 3 (e.g., more than 90% by count) have a diameter in the range of 5-7 mm, and a small count of cavities or bubbles whose diameters fall outside the range of 5-7 mm may still be present.

In some embodiments, the light guide column has a single layer of bubbles 3, and the bubbles 3 have a relatively large size and a relatively dense distribution spacing.

In some embodiments, as shown in FIG. 20, the luminous intensity distribution curve of the light guide column with the single layer of large bubbles in the inner portion includes a first intensity distribution region A and two second intensity distribution regions (B) located on both sides of the first intensity distribution region A. In some embodiments, the luminous intensity distribution curve in the first intensity distribution region A has a transverse trend. For example, the first intensity distribution region A with the transverse trend is formed within an azimuth angle range of approximately -13° to +13° in FIG. 20. In some embodiments, the luminous intensity distribution curve in each of the two second intensity distribution regions B has an increasing trend or a decreasing trend. For example, the second intensity distribution region B with the increasing trend is formed within an azimuth angle range of approximately -85° to -13° in FIG. 20. The second intensity distribution region B with the decreasing trend is formed within an azimuth angle range of approximately +13° to +85° in FIG. 20.

In some embodiments, as shown in FIG. 20, a 50% beam angle of the light guide column is in a range of 80-90°. The light guide column has a large illumination angle, is suitable for wide-area illumination, and can cover an entire space. For example, a beam angle of the light guide column on a C0°-C180° measurement plane is 83.5°. As another example, a beam angle of the light guide column on a C90°-C270° measurement plane is 87.8°. In some embodiments, the 50% beam angle also refers to as a full width at half maximum beam angle. The 50% beam angle refers to an angle formed by light rays on two sides when a light intensity drops to 50% of a maximum central value, with a central optical axis of the luminaire (e.g., the light guide column assembled with a light source) as a reference.

In some embodiments of the present disclosure, as shown in FIG. 25, process 1000 may be applied to manufacture the aforementioned light guide column with the single layer of large bubbles in the inner portion. In some embodiments, the light guide column may include one layer of bubbles. In some embodiments, the interior of the columnar structure 1 of the light guide column includes a first annular region 21 and two second regions 22 centered on the axis of the columnar structure 1. The first annular region 21 includes bubbles 3. A diameter of each of the bubbles 3 of the light guide column is in a range of 5-7 mm, and a maximum spacing between adjacent bubbles 3 is selected from a range of 3-6 mm. In some embodiments, as a result of process precision, a majority of the bubbles 3 within the first annular region 21 (e.g., more than 90% by count) have a diameter in the range of 5-7 mm, and a small count of cavities or bubbles whose diameters fall outside the range of 5-7 mm may still be present within the first annular region 21.

In some embodiments, step 1100 may include: providing the light guide column material, the light guide column material including a first material for forming a second region 22 located on an inner portion, a second material for forming the first annular region 21 located in a middle portion, and a third material for forming a second region 22 located on an outer portion. Each of the first material and the third material includes the plastic material, and the second material includes the plastic material, the fast-acting foaming agent, and the slow-acting foaming agent.

In some embodiments, the second material includes, by mass parts: 96-97.5 parts of the plastic material, 0.8-1 part of the fast-acting foaming agent, and 0.3-0.45 parts of the slow-acting foaming agent. Merely by way of example, the second material may include, by mass parts: 97 parts of the plastic material, 0.9 parts of the fast-acting foaming agent, and 0.4 parts of the slow-acting foaming agent. For example, the 0.9 parts of the fast-acting foaming agent may include 0.9 parts of the azodicarbonamide foaming agent; the 0.4 parts of the slow-acting foaming agent may include 0.3 parts of sodium bicarbonate compounded with 0.1 parts of citric acid.

In some embodiments, step 1200 may include: causing the light guide column material to be at a first temperature and a first pressure, to melt the plastic material while avoiding decomposition of the fast-acting foaming agent and the slow-acting foaming agent. In some embodiments, the first temperature is 180±1°C (e.g., 180°C). In some embodiments, a slightly higher melting temperature accommodates a higher foaming agent content. In some embodiments, the first pressure is 1.5±0.1 MPa (e.g., 1.5 MPa). In some embodiments, a higher first pressure enables the stable conveyance of the highly viscous molten light guide column material while effectively suppressing foaming of both the fast-acting and slow-acting foaming agents.

In some embodiments, step 1200 may include: causing the light guide column material to be at a second temperature and a second pressure, to initiate decomposition of the slow-acting foaming agent and the fast-acting foaming agent. The second temperature is within the effective decomposition temperature range of the slow-acting foaming agent and the effective decomposition temperature range of the fast-acting foaming agent, and the second pressure is lower than the first pressure. In some embodiments, the second temperature is 210±1°C (e.g., 210°C). In some embodiments, at the second temperature, the fast-acting foaming agent and the slow-acting foaming agent are simultaneously activated and generate gas. In some embodiments, the second pressure is 0.6±0.1 MPa (e.g., 0.6 MPa). In some embodiments, a lower second pressure can promote gas nucleation and coalescence.

In some embodiments, step 1200 may include: causing the light guide column material to be at a third temperature and a third pressure, to further decompose the fast-acting foaming agent. The third temperature is higher than the highest effective decomposition temperature of the fast-acting foaming agent, and the third pressure is lower than the second pressure. In some embodiments, the third temperature is 230±1°C (e.g., 230°C). In some embodiments, at the third temperature, the ultra-high temperature accelerates decomposition of the fast-acting foaming agent, and the gas expands violently to form large bubbles. In some embodiments, the third pressure is 0.2±0.1 MPa (e.g., 0.2 MPa). In some embodiments, the ultra-low third pressure maximizes bubble expansion, enabling the diameters of the bubbles to reach 5-7 mm.

In some embodiments, step 1200 may include: causing the light guide column material to be at a fourth temperature and a fourth pressure, to reduce decomposition of the fast-acting foaming agent. The fourth temperature is within the effective decomposition temperature range of the slow-acting foaming agent and the effective decomposition temperature range of the fast-acting foaming agent, the fourth temperature is lower than the second temperature, the fourth pressure includes a peripheral pressure and a central pressure, and the peripheral pressure is greater than the central pressure. In some embodiments, the fourth temperature is 200±1°C (e.g., 200°C). In some embodiments, at the fourth temperature, the temperature is moderately seted to further fine-tune the bubble size. In some embodiments, the peripheral pressure of the fourth pressure is 1.0±0.1 MPa (e.g., 1.0 MPa). In some embodiments, the central pressure of the fourth pressure is 0.2±0.1 MPa (e.g., 0.2 MPa). In some embodiments, the low peripheral pressure combined with the even lower central pressure allows a small amount of bubble migration, forming a natural gradient.

In some embodiments, step 1300 may include: performing pre-cooling on the light guide column material. In some embodiments, the pre-cooling may include air cooling. In some embodiments, the cooling temperature for the air cooling may be 50°C, and the air speed may be 3 m/s. In some embodiments, the cooling rate for the pre-cooling may be 1.5 °C/s. In some embodiments, the light guide column material can accelerate surface solidification during the pre-cooling process, limiting disordered diffusion of bubbles.

In some embodiments, step 1300 may include: performing main cooling on the light guide column material. In some embodiments, the main cooling may include cooling in a warm water tank. In some embodiments, the cooling temperature of the warm water tank may be 80°C, and a flow rate of the warm water tank may be 8 L/min. In some embodiments, the cooling rate of the main cooling is greater than the cooling rate of the pre-cooling. In some embodiments, the cooling rate of the main cooling may be 2 to 3 times the cooling rate of the pre-cooling. In some embodiments, the cooling rate of the main cooling may be 4 °C/s. In some embodiments, the high-temperature water in the warm water tank can delay cooling of the center of the light guide column, promoting bubble coalescence.

In some embodiments, step 1300 may include: performing final cooling on the light guide column material. In some embodiments, the final cooling may include ice water spraying. In some embodiments, the spraying temperature of the ice water spraying may be 5°C, and the spraying pressure may be 0.4 MPa. In some embodiments, the cooling rate of the final cooling is greater than the cooling rate of the main cooling. In some embodiments, the cooling rate of the final cooling may be 1.5 to 2 times the cooling rate of the main cooling. In some embodiments, the cooling rate of the final cooling may be 7 °C/s. In some embodiments, the light guide column material is rapidly cooled during the final cooling process, thereby locking the large bubble structure.

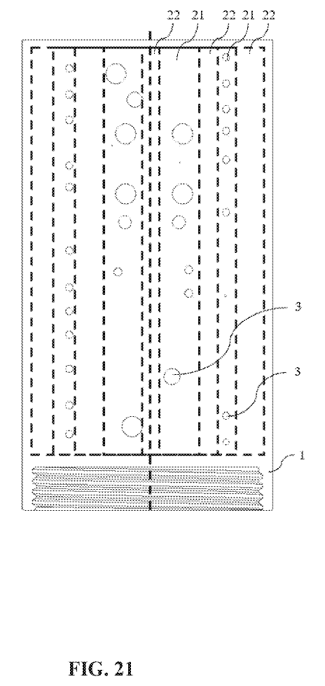

FIG. 21 is a schematic diagram illustrating a light guide column with double-layer bubbles according to some embodiments of the present disclosure. As shown in FIG. 21, in some embodiments of the present disclosure, the light guide column may have a double-layer bubble. In some embodiments, the light guide column may include at least one first annular region 21. The at least one first annular region 21 may include bubbles 3. A count of the at least one first annular region 21 may be two. In some embodiments, the bubbles 3 include first bubbles 31 and second bubbles 32. In some embodiments, an interior of one of the first annular regions 21 has the first bubbles 31, and an interior of the remaining first annular region(s) 21 has the second bubbles 32. In some embodiments, a diameter of the first bubbles 31 is less than a diameter of the second bubbles 32. In some embodiments, a first annular region 21 containing the first bubbles 31 surrounds an exterior of a first annular region 21 containing the second bubbles 32.

In some embodiments, the light guide column may sequentially include, from a center to a periphery, a second region 22 at the center, a first annular region 21 at a middle portion, a second region 22 at the middle portion, another first annular region 21 at the middle portion, and a second region 22 at the periphery. In some embodiments, the diameter of the columnar structure 1 of the light guide column may be 50±5 mm. In some embodiments, a diameter of the second region 22 located at the center may be about 4±2 mm. A ring width of the first annular region 21 at the middle portion may be about 5-7 mm (e.g., equivalent to a width of one second bubble 32). A ring width of the second region 22 at the middle portion may be about 8±1 mm. A ring width of the other first annular region 21 at the middle portion may be about 1.5-2 mm (e.g., equivalent to a width of one first bubble 31). A ring width of the second region 22 at the periphery may be about 10 mm.

In some embodiments, a diameter of each of the first bubbles 31 is in a range of 1.5 to 2 mm. For example, the diameter of each of the first bubbles 31 may be 1.5 mm, 1.55 mm, 1.6 mm, 1.7 mm, 1.72 mm, 1.85 mm, 1.9 mm, or 2.0 mm. In some embodiments, a maximum spacing between adjacent first bubbles 31 is selected from a range of 8 to 10 mm. For example, the maximum spacing between adjacent first bubbles 31 may be selected from 8 mm, 8.2 mm, 8.5 mm, 9 mm, 9.65 mm, or 10 mm. In some embodiments, as a result of process precision, a majority of the first bubbles 31 (e.g., more than 90% by count) have a diameter in the range of 1.5-2 mm, and a small count of cavities or bubbles whose diameters fall outside the range of 1.5-2 mm may still be present.

In some embodiments, a diameter of each of the second bubbles 32 is in a range of 5 to 7 mm. For example, the diameter of each of the second bubbles 32 may be 5 mm, 5.5 mm, 5.6 mm, 6 mm, 6.15 mm, 6.85 mm, 6.9 mm, or 7.0 mm. In some embodiments, a maximum spacing between adjacent second bubbles 32 is selected from a range of 3 to 6 mm. For example, the maximum spacing between adjacent second bubbles 32 may be selected from 3 mm, 4 mm, 4.5 mm, 5 mm, 5.65 mm, or 6 mm. In some embodiments, as a result of process precision, a majority of the second bubbles 32 (e.g., more than 90% by count) have a diameter in the range of 5-7 mm, a small number of cavities or bubbles whose diameters fall outside the range of 5-7 mm may still be present.

In some embodiments, the light guide column has the double-layer bubbles 3 (e.g., the first bubbles 31 and the second bubbles 32). The second bubbles 32 in an inner layer have a relatively large size. The second bubbles 32 in the inner layer have a moderate distribution spacing. The first bubbles 31 in an outer layer have a relatively small size. The first bubbles 31 in the outer layer have a relatively dense distribution spacing.

In some embodiments of the present disclosure, a count of the at least one first annular region 21 is two or more (e.g., three, four, or five). In some embodiments, the bubbles 3 include first bubbles and second bubbles, and may further include sixth bubbles, seventh bubbles, or eighth bubbles. In some embodiments, an interior of one or more of the at least one first annular region 21 has bubbles 3 of one size. An interior of one or more remaining first annular region(s) 21 has bubbles 3 of another size. In some embodiments, the bubbles 3 with a smaller size may surround outside of the bubbles 3 with a larger size. In some embodiments, the bubbles 3 with a larger size may surround outside of the bubbles 3 with a smaller size. In some embodiments, the bubbles 3 with a smaller size and the bubbles 3 with a larger size may be arranged alternately.

Merely by way of example, an interior of a columnar structure 1 has a plurality of layers of first annular regions 21 (e.g., two or more layers of first annular regions 21). Sizes of the bubbles 3 within each layer of the first annular regions 21 sequentially decrease from an inner portion to an outer portion. In some embodiments, incident light passes through the bubbles 3 in a first annular region 21 in the inner portion to form first light rays scattered outward. The first light rays pass through the bubbles 3 in the first annular region 21 at a middle portion or an outer portion to form second light rays scattered further outward. In some embodiments, a larger bubbles 3 in the first annular region 21 closer to the inner portion may be configured to distribute light to various angles. A smaller bubbles 3 in the first annular region 21 closer to the outer portion may be configured to adjust an intensity distribution of the light at the various angles, thereby forming a more uniform, soft lighting effect with a water ripple pattern.

As another example, in two adjacent first annular regions 21, a count of the bubbles 3 in the first annular region 21 closer to an outer surface of the columnar structure 1 is greater than a count of the bubbles 3 in the first annular region 21 closer to a center of the columnar structure 1. In some embodiments, because the bubbles 3 in the first annular region 21 closer to the outer portion are smaller, a count of the bubbles 3 in the first annular region 21 closer to the outer portion may be greater. This allows for more frequent and denser refraction, thereby forming a soft light effect.

In some embodiments of the present disclosure, as shown in FIG. 25, process 1000 may be applicable to manufacturing the aforementioned light guide column with the double-layer bubbles. In some embodiments, the light guide column may include two layers of bubbles. In some embodiments, the interior of the columnar structure 1 of the light guide column includes the at least one first annular region 21 and second regions 22 centered on the axis of the columnar structure 1, the at least one first annular region 21 and the second regions 22 are alternately arranged sequentially from a center of the columnar structure 1 to an outer portion (or a periphery) of the columnar structure 1, a count of the at least one first annular region 21 is at least two, an interior of one of the at least one first annular region 21 has first bubbles 31, and an interior of another of the at least one first annular region 21 has second bubbles 32. In some embodiments, the diameter of the second bubbles 32 in the interior of the first annular region 21 closer to the center is in a range of 5 to 7 mm. The diameter of the first bubbles 31 in the interior of the first annular region 21 closer to the outer portion is in a range of 1.5 to 2 mm. In some embodiments, as a result of process precision, a majority of the second bubbles 32 within the first annular region 21 closer to the center (e.g., more than 90% by count) have a diameter in the range of 5-7 mm, and a small count of cavities or bubbles whose diameters fall outside the range of 5-7 mm may still be present within the first annular region 21 closer to the center. Similarly, as a result of process precision, a majority of the first bubbles 31 within the first annular region 21 closer to the periphery (e.g., more than 90% by count) have a diameter in the range of 1.5-2 mm, and a small count of cavities or bubbles whose diameters fall outside the range of 1.5-2 mm may still be present within the first annular region 21 closer to the periphery.

In some embodiments, step 1100 may include: providing the light guide column material, the light guide column material includes a first material for forming a second region 22 located on an inner portion, a second material and a third material for forming two first annular regions 21 located in a middle portion, a fourth material for forming a second region 22 located between the two first annular regions 21, and a fifth material for forming a second region 22 located on an outer portion, each of the second material and the third material includes the plastic material, the fast-acting foaming agent, and the slow-acting foaming agent, and each of the first material, the fourth material, and the fifth material includes the plastic material;

In some embodiments, the second material for forming the first annular region 21 located at the middle portion and closer to the inner portion includes, by mass parts: 98 parts of the plastic material and 0.8 parts of the fast-acting foaming agent.

In some embodiments, the third material for forming the first annular region 21 located at the middle portion and closer to the outer portion includes, by mass parts: 98 parts of the plastic material and 0.8 parts of the slow-acting foaming agent. Merely by way of example, the 0.8 parts of the slow-acting foaming agent may include 0.6 parts of sodium bicarbonate compounded with 0.2 parts of citric acid.

In some embodiments, providing the light guide column material in step 1100 may include: providing the first material, the fourth material, and the fifth material, and after a first time interval, providing the second material and the third material. In some embodiments, the first material, the fourth material, and the fifth material are provided first. 2 to 3 seconds later, the second material and the third material are provided. This allows the first material, the fourth material, and the fifth material to form a barrier first.

In some embodiments, an injection speed of each of the first material, the fourth material, and the fifth material is greater than an injection speed of the second material. In some embodiments, the injection speed of each of the first material, the fourth material, and the fifth material is greater than an injection speed of the third material. In some embodiments, the injection speed of the second material is less than the injection speed of the third material.

In some embodiments, step 1200 may include: independently performing temperature control and pressure control on the second material and the third material, respectively, to independently form the first bubbles and the second bubbles inside the second material and the third material, respectively.

In some embodiments, the independently performing temperature control and pressure control on the second material and the third material, respectively, to independently form the first bubbles and the second bubbles inside the second material and the third material, respectively, may include steps S1-S4.

Step S1: melting the second material and the third material, while avoiding decomposition of the fast-acting foaming agent and the slow-acting foaming agent, and providing different pressures to the second material and the third material.

Step S2: setting a temperature of the second material within the effective decomposition temperature range of the slow-acting foaming agent and the effective decomposition temperature range of the fast-acting foaming agent, to initiate decomposition of the slow-acting foaming agent and the fast-acting foaming agent; setting a temperature of the third material within the effective decomposition temperature range of the slow-acting foaming agent and lower than the lowest effective decomposition temperature of the fast-acting foaming agent, to initiate decomposition of the slow-acting foaming agent.

Step S3: setting the temperature of the second material higher than or equal to the highest effective decomposition temperature of the fast-acting foaming agent, to completely decompose the fast-acting foaming agent; setting the temperature of the third material within the effective decomposition temperature range of the slow-acting foaming agent and the effective decomposition temperature range of the fast-acting foaming agent, to decompose the slow-acting foaming agent and the fast-acting foaming agent.

Step S4: reducing the temperature of the second material and the temperature of the third material, to set positions of the two first annular regions.

In some embodiments, step S1 may include: setting the second material at a first inner layer temperature and a first inner layer pressure, and setting the third material at a first outer layer temperature and a first outer layer pressure, to melt the plastic material while avoiding decomposition of the fast-acting foaming agent and the slow-acting foaming agent. In some embodiments, the first inner layer temperature and a second inner layer temperature are equal. In some embodiments, the first inner layer temperature and the first outer layer temperature may both be 170±1°C, for example, 170°C. In some embodiments, the first inner layer pressure may be 1.0±0.1 MPa, for example, 1.0 MPa. In some embodiments, the first outer layer pressure may be 1.2±0.1 MPa, for example, 1.2 MPa. In some embodiments, the independent first inner layer pressure and first outer layer pressure can prevent interlayer permeation while stably conveying the melt.

In some embodiments, S2 may include: setting the second material at a second inner layer temperature and a second inner layer pressure, and setting the third material at a second outer layer temperature and a second outer layer pressure, to pre-decompose the fast-acting foaming agent in the second material and to activate the slow-acting foaming agent in the third material. In some embodiments, the second inner layer temperature may be 210±1°C, for example, 210°C, to pre-decompose the fast-acting foaming agent. In some embodiments, the second outer layer temperature may be 180±1°C, for example, 180°C, to activate the slow-acting foaming agent. In some embodiments, the second inner layer pressure may be 0n5±0.1 MPa, for example, 0.5 MPa. In some embodiments, the second outer layer pressure may be 0.8±0.1 MPa, for example, 0.8 MPa. In some embodiments, the third material of the outer layer is at a medium pressure to restrict bubble diffusion, and the second material of the inner layer is at a low pressure to promote bubble growth.

In some embodiments, S2 further includes: performing a first stirring on the second material, keeping the fourth material stationary, and performing a second stirring on the third material. In some embodiments, a stirring speed of the first stirring is greater than a stirring speed of the second stirring. In some embodiments, the stirring speed of the first stirring located in the middle portion close to the inner layer is 20 rpm, which has low shear force and is suitable for protecting large bubbles. In some embodiments, the fourth material located in the middle portion between the inner layer and the outer layer is kept stationary to maintain isolation. In some embodiments, keeping the fourth material stationary refers to not stirring the fourth material, but still causing the fourth material to move along an extrusion direction of the material. In some embodiments, the stirring speed of the second stirring located in the middle portion close to the outer layer is 40 rpm, which has high shear force and is suitable for refining small bubbles.

In some embodiments, S3 includes: setting the second material at a third inner layer temperature and a third inner layer pressure, and setting the third material at a third outer layer temperature and a third outer layer pressure. In some embodiments, the third inner layer temperature is 225±1°C (e.g., 225°C), to cause the fast-acting foaming agent in the second material to completely decompose to form large bubbles. In some embodiments, the third outer layer temperature is 200±1°C (e.g., 200°C), to cause the slow-acting foaming agent in the third material to steadily decompose to form small bubbles. In some embodiments, the third inner layer pressure is 0.3±0.1 MPa (e.g., 0.3 MPa). In some embodiments, the third outer layer pressure is 0.7±0.1 MPa (e.g., 0.7 MPa). In some embodiments, the third material of the outer layer is seted at a medium pressure to refine bubbles, and the second material of the inner layer is at an ultra-low pressure to amplify a size of the bubbles.

In some embodiments, S4 includes: setting the second material at a fourth inner layer temperature and a fourth inner layer pressure, setting the third material at a fourth outer layer temperature and a fourth outer layer pressure, and simultaneously setting the fourth material at a fourth middle layer pressure. In some embodiments, the fourth inner layer temperature and the fourth outer layer temperature are equal. In some embodiments, both the fourth inner layer temperature and the fourth outer layer temperature may be 190±1°C (e.g., 190°C) to solidify the double-layer structure through overall cooling. In some embodiments, the fourth outer layer pressure is greater than the fourth middle layer pressure, and the fourth middle layer pressure is greater than the fourth inner layer pressure. In some embodiments, the fourth inner layer pressure is 0.3±0.1 MPa (e.g., 0.3 MPa). In some embodiments, the fourth middle layer pressure is 1.0±0.1 MPa (e.g., 1.0 MPa). In some embodiments, the fourth outer layer pressure is 1.5±0.1 MPa (e.g., 1.5 MPa). In some embodiments, the fourth inner layer pressure, the fourth middle layer pressure, and the fourth outer layer pressure form a three-layer pressure gradient to lock positions of bubbles in the two first annular regions 21.

In some embodiments, step 1300 includes: performing cooling control on the second material and the third material independently, respectively, to solidify the light guide column material and obtain the light guide column.

In some embodiments, step 1300 may include: performing pre-cooling on the light guide column material. In some embodiments, the pre-cooling may include air cooling. In some embodiments, the cooling temperature for the air cooling may be 40°C, and the air speed may be 2 m/s. In some embodiments, the cooling rate for the pre-cooling may be 1 °C/s. In some embodiments, the light guide column material undergoes slow cooling during the pre-cooling process, thereby allowing the large bubbles in the center to sustain their expansion.

In some embodiments, step 1300 may include: performing main cooling on the light guide column material. In some embodiments, the main cooling may include cooling in a warm water tank. In some embodiments, the cooling temperature of the warm water tank may be 70°C, and a flow rate of the warm water tank may be 6 L/min. In some embodiments, the cooling rate of the main cooling is greater than the cooling rate of the pre-cooling. In some embodiments, the cooling rate of the main cooling may be 2 to 3 times the cooling rate of the pre-cooling. In some embodiments, the cooling rate of the main cooling may be 3 °C/s. In some embodiments, the main cooling causes the outer wall of the light guide column material to rapidly solidify, thereby locking the distribution of small bubbles while maintaining a certain degree of fluidity in the central portion.

In some embodiments, step 1300 may include: performing final cooling on the light guide column material. In some embodiments, the final cooling may include ice water spraying. In some embodiments, the spraying temperature of the ice water spraying may be 10°C, and the spraying pressure may be 0.3 MPa. In some embodiments, the cooling rate of the final cooling is greater than the cooling rate of the main cooling. In some embodiments, the cooling rate of the final cooling may be 1.5 to 2 times the cooling rate of the main cooling. In some embodiments, the cooling rate of the final cooling may be 5 °C/s.

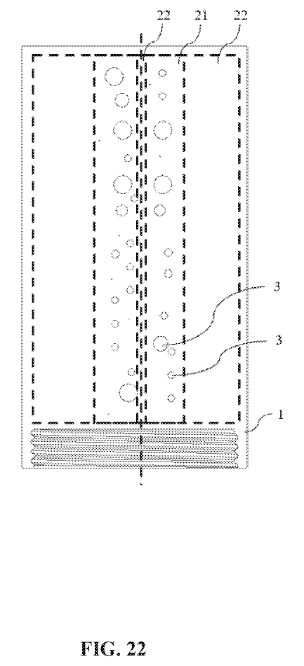

FIG. 22 is a schematic diagram illustrating a light guide column with a single layer of mixed large bubbles and small bubbles in an inner portion according to some embodiments of the present disclosure; FIG. 23 is a schematic diagram illustrating a luminous intensity distribution curve of the light guide column with the single layer of mixed large bubbles and small bubbles in the inner portion shown in FIG. 22. As shown in FIG. 22 and FIG. 23, in some embodiments of the present disclosure, the light guide column may have single-layer mixed large and small bubbles in the inner portion. In some embodiments, the light guide column includes at least one first annular region 21. The at least one first annular region 21 includes bubbles 3. A count of the at least one first annular region 21 is one. The bubbles 3 include third bubbles and fourth bubbles. A diameter of each of the third bubbles is less than a diameter of each of the fourth bubbles. In other words, an interior of a same annular region 21 has bubbles 3 (e.g., the third bubbles and the fourth bubbles) with two different diameters.

In some embodiments, the light guide column sequentially includes, from a center to a periphery, a second region 22 located at the center, the first annular region 21 located in a middle portion, and the second region 22 located at the periphery. In some embodiments, a diameter of a columnar structure 1 of the light guide column is 50±5 mm. In some embodiments, a diameter of the second region 22 located at the center is about 4±2 mm, a ring width of the first annular region 21 located in the middle portion is in a range of 5 to 8 mm, and a ring width of the second region 22 located at the periphery is about 15±1 mm.

In some embodiments, a diameter of each of the third bubbles is in a range of 1.5 to 2 mm. For example, the diameter of each of the third bubbles is 1.5 mm, 1.5 mm, 1.6 mm, 1.65 mm, 1.752 mm, 1.8 mm, 1.95 mm, or 2.0 mm. In some embodiments, as a result of process precision, a majority of the third bubbles (e.g., more than 90% by count) have a diameter in the range of 1.5-2 mm, and a small count of cavities or bubbles whose diameters fall outside the range of 1.5-2 mm may still be present. In some embodiments, a diameter of each of the fourth bubbles is in a range of 5 to 7 mm. For example, the diameter of each of the fourth bubbles is 5.0 mm, 5.25 mm, 5.6 mm, 5.65 mm, 6.0 mm, 6.5 mm, 6.85 mm, or 7.0 mm. In some embodiments, as a result of process precision, a majority of the fourth bubbles (e.g., more than 90% by count) have a diameter in the range of 5-7 mm, and a small count of cavities or bubbles whose diameters fall outside the range of 5-7 mm may still be present. In some embodiments, a maximum spacing between adjacent bubbles 3 is selected from a range of 3 to 6 mm. For example, the maximum spacing between adjacent bubbles (including the third bubbles and the fourth bubbles) is selected from 3 mm, 3.5 mm, 4.8 mm, 5 mm, 5.65 mm, or 6 mm.

In some embodiments, adjacent bubbles 3 refer to two bubbles 3 (which may be the third bubble or the fourth bubble) in the same first annular region 21 that are closest to each other in physical space, with no other bubbles 3 directly proximate to these two bubbles 3 between them. In some embodiments, the maximum spacing refers to the spacing between the two bubbles 3 (which may be the third bubble or the fourth bubble) with the largest spacing among all bubbles 3 inside the same first annular region 21. It should be understood that the spacing between bubbles 3 inside the same first annular region 21 may be less than the maximum spacing. In some embodiments, the spacing between bubbles 3 refers to the shortest spatial distance from the surface of one bubble 3 to the surface of another bubble 3.

In some embodiments, the light guide column has a single layer of bubbles 3. The bubbles 3 have different sizes. Large and small bubbles are mixed in distribution. The distribution spacing is relatively dense.

In some embodiments, as shown in FIG. 23, the luminous intensity distribution curve of the light guide column with the single layer of mixed-size bubbles in the inner portion includes a first intensity distribution region A and two second intensity distribution regions B located on both sides of the first intensity distribution region A. In some embodiments, the luminous intensity distribution curve in the first intensity distribution region A has a transverse trend. For example, the first intensity distribution region A with the transverse trend is formed within an azimuth angle range of approximately -12° to +12° in FIG. 23. In some embodiments, the luminous intensity distribution curve in each of the two second intensity distribution regions B has an increasing trend or a decreasing trend. For example, the second intensity distribution region B with the increasing trend is formed within an azimuth angle range of approximately -80° to -12° in FIG. 23. The second intensity distribution region B with the decreasing trend is formed within an azimuth angle range of approximately +12° to +80° in FIG. 23.

In some embodiments, as shown in FIG. 23, a 50% beam angle of the light guide column is in a range of 92° to 98°. The light guide column has a large illumination angle, is suitable for wide-area illumination, and can cover an entire space. For example, a beam angle of the light guide column on a C0°-C180° measurement plane is 92.5°. As another example, a beam angle of the light guide column on a C90°-C270° measurement plane is 93.9°. In some embodiments, the 50% beam angle also refers to as a full width at half maximum beam angle. The 50% beam angle refers to an angle formed by light rays on two sides when a light intensity drops to 50% of a maximum central value, with a central optical axis of the luminaire (e.g., the light guide column assembled with a light source) as a reference.

In some embodiments of the present disclosure, the count of the at least one first annular region 21 is one. The bubbles 3 include third bubbles and fourth bubbles, and may further include ninth bubbles and/or tenth bubbles with different diameters.

In some embodiments of the present disclosure, the light effect of the light guide column may be adjusted by setting the size of the bubbles 3. In some embodiments, a larger size of the bubbles 3 results in a stronger contrast of the light effect. In the formed stripes with alternating bright and dark areas, the contrast between the bright area and the dark area is more pronounced. In some embodiments, a smaller size of the bubbles 3 results in a softer light effect. The light is scattered uniformly. In the formed stripes with alternating bright and dark areas, the contrast between the bright area and the dark area is smaller.

In some embodiments, the morphology of the light effect may be adjusted by setting the density of the bubbles 3. In some embodiments, a higher density of the bubbles 3 results in more complex stripes with alternating bright and dark areas. The light effect has higher artistry, but there is some loss of brightness. In some embodiments, a lower density of the bubbles 3 results in a relatively simple light effect and better lighting performance.

In some embodiments, the spatial distribution of the bubbles 3 can also affect the light effect. In some embodiments, a more concentrated distribution of the bubbles 3 results in stronger geometric characteristics of the light effect, for example, the light effect appears radial or like a light column. In some embodiments, a more random distribution of the bubbles 3 results in higher complexity of the light effect, enabling the formation of complex effects such as starry sky projection.

In some embodiments, the shape of the bubbles 3 can also affect the light effect. In some embodiments, a more regular shape of the bubbles 3, for example, closer to a circle or an ellipse, results in a light effect with strong symmetry and a natural halo transition. In some embodiments, a more irregular shape of the bubbles 3 results in a light effect with a strong sense of dynamics and artistry.

In some embodiments of the present disclosure, as shown in FIG. 25, process 1000 may be applied to manufacture the aforementioned light guide column with the single layer of mixed-size bubbles in the inner portion. In some embodiments, the light guide column may include one layer of bubbles. In some embodiments, the interior of the columnar structure 1 of the light guide column includes a first annular region 21 and two second regions 22 centered on the axis of the columnar structure 1. The first annular region 21 includes third bubbles and fourth bubbles. A diameter of each of the third bubbles is in a range of 1.5-2 mm, a diameter of each of the fourth bubbles is in a range of 5-7 mm, and a maximum spacing between adjacent bubbles 3 is selected from a range of 3-6 mm. In some embodiments, as a result of process precision, a majority of the third bubbles (e.g., more than 90% by count) have a diameter in the range of 1.5-2 mm, and a small count of cavities or bubbles whose diameters fall outside the range of 1.5-2 mm may still be present. Similarly, as a result of process precision, a majority of the fourth bubbles (e.g., more than 90% by count) have a diameter in the range of 5-7 mm, and a small count of cavities or bubbles whose diameters fall outside the range of 5-7 mm may still be present.

In some embodiments, step 1100 may include: providing the light guide column material, the light guide column material including a first material for forming a second region 22 located on an inner portion, a second material for forming the first annular region 21 located in a middle portion, and a third material for forming a second region 22 located on an outer portion. Each of the first material and the third material include the plastic material, and the second material includes the plastic material, the fast-acting foaming agent, and the slow-acting foaming agent.

In some embodiments, the second material includes, by mass parts: 97.5 parts of the plastic material, 0.5 parts of the fast-acting foaming agent, and 0.8 parts of the slow-acting foaming agent. Merely by way of example, the 0.5 parts of the fast-acting foaming agent may include 0.5 parts of the azodicarbonamide foaming agent; the 0.8 parts of the slow-acting foaming agent may include 0.5 parts of sodium bicarbonate compounded with 0.3 parts of citric acid.

In some embodiments, step 1200 may include: causing the light guide column material to be at a first temperature and a first pressure, to melt the plastic material while avoiding decomposition of the fast-acting foaming agent and the slow-acting foaming agent. In some embodiments, the first temperature is 175±1°C (e.g., 175°C). In some embodiments, a slightly higher melting temperature accommodates a higher foaming agent content, while enabling uniform melting and preventing localized concentration of the foaming agents at the first temperature. In some embodiments, the first pressure is 1.3±0.1 MPa (e.g., 1.3 MPa). In some embodiments, a relatively high first pressure enables the stable conveyance of the highly viscous molten light guide column material while effectively suppressing foaming of both the fast-acting and slow-acting foaming agents.

In some embodiments, step 1200 may include: causing the light guide column material to be at a second temperature and a second pressure, to initiate decomposition of the slow-acting foaming agent and the fast-acting foaming agent. The second temperature is within the effective decomposition temperature range of the slow-acting foaming agent and the effective decomposition temperature range of the fast-acting foaming agent, and the second pressure is lower than the first pressure. In some embodiments, the second temperature is 200±1°C (e.g., 200°C). In some embodiments, at the second temperature, the fast-acting foaming agent and the slow-acting foaming agent are simultaneously activated and generate gas. In some embodiments, the second pressure is 0.7±0.1 MPa (e.g., 0.7 MPa). In some embodiments, a moderate second pressure can promote nucleation of small bubbles while suppressing premature expansion of large bubbles.

In some embodiments, step 1200 may include: causing the light guide column material to be at a third temperature and a third pressure, to completely decompose the fast-acting foaming agent. The third temperature is within the effective decomposition temperature range of the slow-acting foaming agent and the effective decomposition temperature range of the fast-acting foaming agent, or the third temperature is equal to the highest effective decomposition temperature of the fast-acting foaming agent. The third temperature is higher than the second temperature, and the third pressure is lower than the second pressure. In some embodiments, the third temperature is 220±1°C (e.g., 220°C). In some embodiments, at the third temperature, the fast-acting foaming agent may be completely decomposed stably, promoting bubble coalescence while retaining small bubbles. In some embodiments, the third pressure is 0.4±0.1 MPa (e.g., 0.4 MPa). In some embodiments, a reduced third pressure allows large bubbles to expand but maintains small bubbles, thus preventing the merging of large and small bubbles.

In some embodiments, step 1200 may include: causing the light guide column material to be at a fourth temperature and a fourth pressure, to reduce decomposition of the fast-acting foaming agent, The fourth temperature is within the effective decomposition temperature range of the slow-acting foaming agent and the effective decomposition temperature range of the fast-acting foaming agent, the fourth temperature is lower than the second temperature, the fourth pressure includes a peripheral pressure and a central pressure, and the peripheral pressure is greater than the central pressure. In some embodiments, the fourth temperature is 195±1°C (e.g., 195°C). In some embodiments, the fourth temperature can balance the final shaping and fine-tuning of large bubbles and small bubbles, allowing a natural distribution of the large bubbles and the small bubbles. In some embodiments, the peripheral pressure of the fourth pressure is 1.2±0.1 MPa (e.g., 1.2 MPa). In some embodiments, the central pressure of the fourth pressure is 0.4±0.1 MPa (e.g., 0.4 MPa). In some embodiments, the medium pressure at the periphery can limit diffusion of large bubbles and small bubbles and the low pressure at the center can maintain a mixed structure of the large bubbles and the small bubbles.

In some embodiments, step 1300 may include: performing pre-cooling on the light guide column material. In some embodiments, the pre-cooling may include air cooling. In some embodiments, the cooling temperature for the air cooling may be 40°C, and the air speed may be 2 m/s. In some embodiments, the cooling rate for the pre-cooling may be 1 °C/s. In some embodiments, the light guide column material undergoes slow cooling during the pre-cooling process, thereby allowing the large bubbles in the center to sustain their expansion.

In some embodiments, step 1300 may include: performing main cooling on the light guide column material. In some embodiments, the main cooling may include cooling in a warm water tank. In some embodiments, the cooling temperature of the warm water tank may be 70°C, and a flow rate of the warm water tank may be 6 L/min. In some embodiments, the cooling rate of the main cooling is greater than the cooling rate of the pre-cooling. In some embodiments, the cooling rate of the main cooling may be 2 to 3 times the cooling rate of the pre-cooling. In some embodiments, the cooling rate of the main cooling may be 3 °C/s. In some embodiments, the main cooling causes the outer wall of the light guide column material to rapidly solidify, thereby locking the distribution of small bubbles while maintaining a certain degree of fluidity in the central portion.

In some embodiments, step 1300 may include: performing final cooling on the light guide column material. In some embodiments, the final cooling may include ice water spraying. In some embodiments, the spraying temperature of the ice water spraying may be 10°C, and the spraying pressure may be 0.3 MPa. In some embodiments, the cooling rate of the final cooling is greater than the cooling rate of the main cooling. In some embodiments, the cooling rate of the final cooling may be 1.5 to 2 times the cooling rate of the main cooling. In some embodiments, the cooling rate of the final cooling may be 5 °C/s.

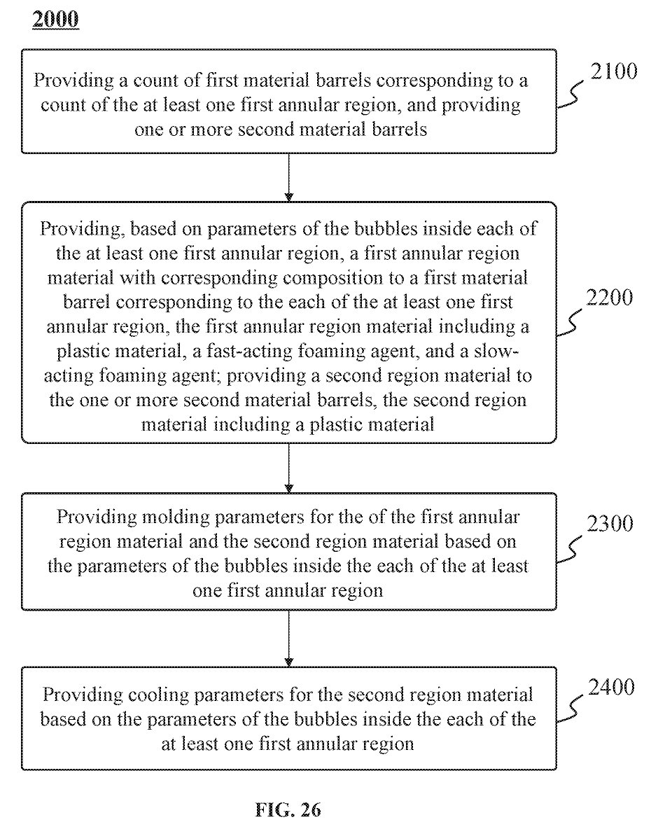

FIG. 26 is an exemplary flowchart illustrating a design process for a method for manufacturing a light guide column according to some embodiments of the present disclosure. As shown in FIG. 26, process 2000 is applicable to obtaining a method for manufacturing the light guide column. The method for manufacturing the light guide column is used to manufacture a light guide column. The light guide column may include a columnar structure 1. The columnar structure 1 is made of a transparent material. An interior of the columnar structure 1 includes at least one first annular region 21 and one or more second regions 22 centered on an axis of the columnar structure 1. The at least one first annular region 21 has bubbles 3 inside. At least a portion of a luminous intensity distribution curve of the light guide column has a serrated pattern. In some embodiments, the process 2000 may include:

Step 2100: Providing first material barrel(s) in a count corresponding to a count of the first annular region(s) 21, and providing one or more second material barrels.

Step 2200: Based on parameters of the bubbles 3 inside each of the first annular region(s) 21, providing a corresponding first annular region material to a first material barrel corresponding to each of the first annular region(s) 21, and providing a second region material to the one or more second material barrels. The first annular region material includes a plastic material, a fast-acting foaming agent, and a slow-acting foaming agent. The second region material includes a plastic material.

Step 2300: Based on the parameters of the bubbles 3 inside each of the first annular region(s) 21, providing molding parameters for the first annular region material and the second region material.

Step 2400: Based on the parameters of the bubbles 3 inside each of the first annular region(s) 21, providing cooling parameters for the first annular region material and the second region material.

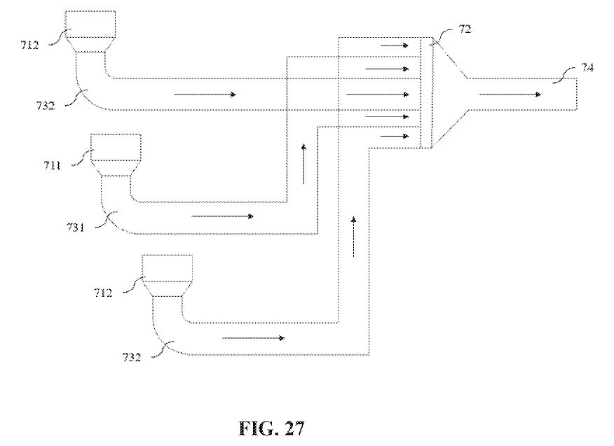

In some embodiments, step 2100 includes designing a light guide column manufacturing apparatus based on a structure of the light guide column to be manufactured. The light guide column manufacturing apparatus includes the first material barrel(s) and the second material barrel(s). In some embodiments, each first annular region 21 corresponds to one first material barrel. First annular region materials corresponding to a plurality of first annular regions 21 are different. In some embodiments, each second region 22 corresponds to one second material barrel, or one or more second regions 22 share a same second material barrel. Second region materials corresponding to the one or more second regions 22 are the same. Merely by way of example, as shown in FIG. 27, the light guide column manufacturing apparatus may include a first material barrel 711 and two second material barrels 712. The first material barrel 711 is configured to provide a material for forming a centrally located first annular region 21. One of the second material barrels 712 is configured to provide a material for forming a centrally located second region 22. The other second material barrel 712 is configured to provide a material for forming an outer second region 22.

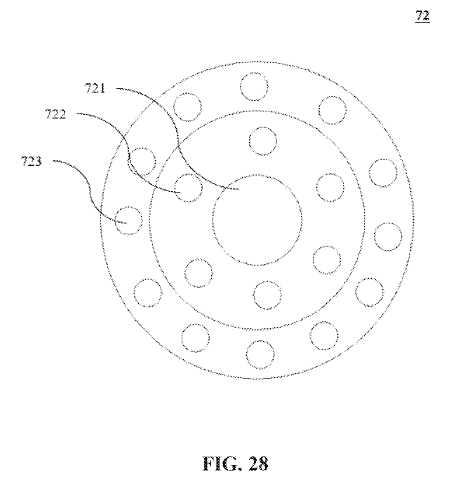

In some embodiments, the light guide column manufacturing apparatus may further include injection ports. Each first annular region 21 corresponds to one injection port. Each second region 22 corresponds to one injection port. In some embodiments, the injection ports may include a central injection port located at a center and a plurality of annular injection ports surrounding the central injection port. In some embodiments, some of the annular injection ports correspond to the first annular regions 21, and the other annular injection ports correspond to the second regions 22. Merely by way of example, as shown in FIG. 27 and FIG. 28, the light guide column manufacturing apparatus may include injection ports 72. The injection ports 72 may include an injection port 721 corresponding to the centrally located second region 22, an injection port 722 corresponding to the centrally located first annular region 21, and an injection port 723 corresponding to the outer second region 22.

In some embodiments, each injection port includes a first end and a second end. In some embodiments, the first end of each injection port is connected to an independent injection channel and is connected to its corresponding first material barrel or second material barrel through the injection channel. In some embodiments, the second end of each injection port is connected to a same cooling channel.

In some embodiments, the first annular region material(s) for forming the first annular region(s) enter one or more corresponding independent first injection channels through independent first material barrels, respectively, and are injected into the cooling channel through one or more respective injection ports. In some embodiments, the second region material(s) for forming the second region(s) 22 enter one or more corresponding independent second injection channels through one second material barrel or through independent second material barrels, respectively, and are injected into the same cooling channel through one or more respective injection ports. Merely by way of example, as shown in FIG. 27, the light guide column manufacturing apparatus may include an independent first injection channel 731, two second injection channels 732, and a cooling channel 74. Merely by way of example, the first injection channel 731 connects the first material barrel 711 and the injection port 722. The first annular region material enters the cooling channel 74 through the injection port 722. One of the second injection channels 732 connects one second material barrel 712 and the injection port 721. The second region material enters the cooling channel 74 through the injection port 721. The other second injection channel 732 connects the other second material barrel 712 and the injection port 723. The second region material enters the cooling channel 74 through the injection port 723.

In some embodiments, the first annular region material(s) and the second region material(s) enter the cooling channel from the injection ports, thereby contacting and connecting with each other within the cooling channel while forming annular structures corresponding to shapes of the injection ports.

In some embodiments, each injection channel includes a first injection zone, a second injection zone, a third injection zone, and a fourth injection zone. In some embodiments, the first injection zone is configured to receive material from the first material barrel or the second material barrel. In some embodiments, the first injection zone is further configured to perform preliminary stirring and/or preliminary heating and melting. In some embodiments, the second injection zone is configured to achieve heating, melting, mixing of a material, and/or preliminary activation of the foaming agents. In some embodiments, the third injection zone is configured to achieve bubble generation and expansion. In some embodiments, the fourth injection zone is configured to adjust a size and a position of a bubble.

In some embodiments, a temperature and a pressure of each of the first injection zone, the second injection zone, the third injection zone, and the fourth injection zone of each injection channel are independently adjustable.

In some embodiments, a cooling channel includes a first cooling zone, a second cooling zone, and a third cooling zone. In some embodiments, the first cooling zone, the second cooling zone, and the third cooling zone of the cooling channel are configurable in different cooling environments. In some embodiments, the cooling environment includes air cooling, warm water bath cooling, and ice water cooling. In some embodiments, a cooling medium in the warm water bath is a liquid. In some embodiments, the cooling medium in the warm water bath includes water, a silicone oil emulsion, an ethylene glycol liquid, a saline solution, or the like.

In some embodiments, in step 2200, parameters of the bubble 3 include a size of the bubbles 3 and a spacing of the bubbles 3.

In some embodiments, step 2200 includes obtaining an effective decomposition temperature range of the fast-acting foaming agent and an effective decomposition temperature range of the slow-acting foaming agent.

In some embodiments, step 2200 includes obtaining a molding objective for each of one or more molding zones based on parameters of the bubbles 3 inside the first annular region(s) 21. Step 2200 further includes obtaining a corresponding operating state of the fast-acting foaming agent and a corresponding operating state of the slow-acting foaming agent for each molding objective. For example, a current bubble state to be achieved in each molding zone is obtained based on the parameters of the bubbles 3 inside the first annular region 21. In some embodiments, the current bubble state includes bubble generation, gas expansion of the bubbles, decompression expansion of the bubbles, suppression of bubble expansion, promotion of bubble coalescence, promotion of bubble position retention, and promotion of bubble migration.

In some embodiments, step 2300 includes obtaining molding parameters based on the operating state of the fast-acting foaming agent and the operating state of the slow-acting foaming agent. In some embodiments, the first annular region material and/or the second region material passes through one or more molding zones. Each molding zone has corresponding molding parameters. In some embodiments, the molding zone includes one or more of the aforementioned first injection zone (e.g., a feeding zone), second injection zone (e.g., a melting zone), third injection zone (e.g., a foaming activation zone), and fourth injection zone (e.g., a fusion zone).

In some embodiments, the molding parameters include a temperature molding parameter and a pressure molding parameter. In some embodiments, obtaining the molding parameters based on the operating state of the fast-acting foaming agent and the operating state of the slow-acting foaming agent includes selecting the temperature molding parameter from the effective decomposition temperature range of the fast-acting foaming agent and the effective decomposition temperature range of the slow-acting foaming agent based on the operating states. Obtaining the molding parameters further includes obtaining the pressure molding parameter based on the parameters of the bubble and the temperature molding parameter.

Merely by way of example, the current bubble state to be achieved in a current molding zone is the generation of small bubbles. Based on this molding objective, a corresponding operating state of the fast-acting foaming agent is obtained as not activating the fast-acting foaming agent. A corresponding operating state of the slow-acting foaming agent is obtained as activating the slow-acting foaming agent. The molding parameters are obtained based on the operating state of the fast-acting foaming agent and the operating state of the slow-acting foaming agent. For example, the temperature molding parameter is obtained. The temperature molding parameter is within the effective decomposition temperature range of the slow-acting foaming agent but is lower than a lowest effective decomposition temperature of the fast-acting foaming agent. This activates the slow-acting foaming agent without activating the fast-acting foaming agent.

Merely by way of example, the current bubble state to be achieved in a current molding zone is generation of large bubbles. Based on this molding objective, a corresponding operating state of the fast-acting foaming agent is obtained as activating the fast-acting foaming agent. A corresponding operating state of the slow-acting foaming agent is obtained as activating the slow-acting foaming agent. The molding parameter is obtained based on the operating state of the fast-acting foaming agent and the operating state of the slow-acting foaming agent. For example, the temperature molding parameter is obtained. The temperature molding parameter is within the effective decomposition temperature range of the fast-acting foaming agent and is also within the effective decomposition temperature range of the slow-acting foaming agent. This simultaneously activates the fast-acting foaming agent and the slow-acting foaming agent.

Merely by way of example, the current bubble state to be achieved in a current molding zone is decompression expansion of the bubbles. Based on this molding objective, a corresponding operating state of the fast-acting foaming agent is obtained as reducing the work of the fast-acting foaming agent. A corresponding operating state of the slow-acting foaming agent is obtained as suppressing the work of the slow-acting foaming agent. The molding parameter is obtained based on the operating state of the fast-acting foaming agent and the operating state of the slow-acting foaming agent. For example, the temperature molding parameter is obtained. The temperature molding parameter is higher than a highest effective decomposition temperature of the slow-acting foaming agent and is near a highest effective decomposition temperature of the fast-acting foaming agent (slightly lower than, equal to, or slightly higher than the highest effective decomposition temperature of the fast-acting foaming agent). The pressure molding parameter is further obtained. For example, the pressure molding parameter is a pressure reduction or maintaining a low pressure to cause decompression expansion of the bubbles.

In some embodiments, in step 2300, cooling parameters include at least one of a count of cooling zones, a cooling medium corresponding to each cooling zone, a cooling temperature corresponding to each cooling zone, a cooling flow rate corresponding to each cooling zone, and a cooling rate corresponding to each cooling zone.

In one or more embodiments of the present disclosure, taking manufacturing a light guide column having three layers of bubbles with bubble sizes decreasing sequentially from a center to an outer portion as an example, process 2000 includes the following.

A light guide column manufacturing apparatus is designed based on a structure of the light guide column. The light guide column includes, from the center to an outer layer, a first bubble-free region (the second region 22), a second bubble-containing region (a first first annular region 21), a third bubble-free region (the second region 22), a fourth bubble-containing region (a second first annular region 21), a fifth bubble-free region (the second region 22), a sixth bubble-containing region (a third first annular region 21), and a seventh bubble-free region (the second region 22).

The light guide column manufacturing apparatus includes material barrels. The material barrels include first material barrels and second material barrels. In some embodiments, a count of the first material barrels is three, corresponding to the second bubble-containing region, the fourth bubble-containing region, and the sixth bubble-containing region, respectively. In some embodiments, a count of the second material barrels is four, corresponding to the first bubble-free region, the third bubble-free region, the fifth bubble-free region, and the seventh bubble-free region, respectively.

In some embodiments, the light guide column manufacturing apparatus includes injection ports. The injection ports include a first injection port, a second injection port, a third injection port, a fourth injection port, a fifth injection port, and a seventh injection port, corresponding to the aforementioned seven regions, respectively.

In some embodiments, the light guide column manufacturing apparatus includes injection channels. The injection channel includes a first injection channel, a second injection channel, a third injection channel, a fourth injection channel, a fifth injection channel, a sixth injection channel, and a seventh injection channel. The seven injection channels are independently connected to the seven material barrels and the seven injection ports, respectively.

In some embodiments, the light guide column manufacturing apparatus further includes one cooling channel. The seven injection ports are connected to the cooling channel.

In some embodiments, a material corresponding to each material barrel is provided based on parameters of bubbles in each layer of the three bubble layers. For example, a first material, a third material, a fifth material, and a seventh material are provided to the first material barrel, the third material barrel, the fifth material barrel, and the seventh material barrel, respectively. The first material, the third material, the fifth material, and the seventh material are all 100% plastic material (e.g., polymethyl methacrylate (PMMA)). For example, a second material is provided to the second material barrel. The second material is the plastic material and 0.8% fast-acting foaming agent. A fourth material is provided to the fourth material barrel. The fourth material is the plastic material and 0.8% slow-acting foaming agent. A sixth material is provided to the sixth material barrel. The sixth material is the plastic material and 0.4% slow-acting foaming agent.

In some embodiments, molding parameters for the first material to the seventh material are determined based on parameters of the bubbles inside each annular region in the light guide column.

Merely by way of example, regions in the light guide column corresponding to the first material, the third material, the fifth material, and the seventh material have no bubbles. Therefore, a temperature molding parameter of a first injection zone (e.g., a feeding zone) of an injection channel (e.g., the first injection channel, the third injection channel, the fifth injection channel, or the seventh injection channel) is configured to 170°C. A pressure molding parameter is configured to 1.2 MPa. This preheats PMMA solid particles to avoid thermal stress cracking. A temperature molding parameter of a second injection zone (e.g., a melting zone) of the injection channel is configured to 200°C. A pressure molding parameter is configured to 1.0 MPa. This completely melts PMMA solid particles to form a transparent fluid while maintaining molecular chain integrity.

Merely by way of example, a region in the light guide column corresponding to the second material requires formation of relatively large bubbles. Therefore, a temperature molding parameter of a first injection zone (e.g., a feeding zone) of the second injection channel is configured to 175°C. A pressure molding parameter is configured to 1.0 MPa. This preheats PMMA solid particles while avoiding premature decomposition of the fast-acting foaming agent. A temperature molding parameter of a second injection zone (e.g., a melting zone) of the second injection channel is configured to 215°C. A pressure molding parameter is configured to 0.5 MPa. This partially activates the fast-acting foaming agent to form initial bubble nuclei. A temperature molding parameter of a third injection zone (e.g., a foaming activation zone) of the second injection channel is configured to 225°C. A pressure molding parameter is configured to 0.3 MPa. This causes complete decomposition of the fast-acting foaming agent, forming large bubbles with a diameter of 5-7 mm.

Merely by way of example, a region in the light guide column corresponding to the fourth material requires formation of moderately sized bubbles. Therefore, a temperature molding parameter of a first injection zone (e.g., a feeding zone) of the fourth injection channel is configured to 165°C (set based on the effective decomposition temperature range of the slow-acting foaming agent in this material). A pressure molding parameter is configured to 1.2 MPa. This preheats PMMA solid particles while avoiding premature decomposition of the slow-acting foaming agent. A temperature molding parameter of a second injection zone (e.g., a melting zone) of the fourth injection channel is configured to 180°C. A pressure molding parameter is configured to 0.8 MPa. This activates the slow-acting foaming agent (e.g., sodium bicarbonate compounded with citric acid) to stably release a gas (e.g., carbon dioxide). A temperature molding parameter of a third injection zone (e.g., a foaming activation zone) of the fourth injection channel is configured to 200°C. A pressure molding parameter is configured to 0.7 MPa. This suppresses the work of the slow-acting foaming agent. The bubble size is limited by the medium pressure. Simultaneously, a stirring speed of 40 rpm is provided to form high shear, adjusting a bubble spacing. For example, the bubble spacing is set to 8-10 mm.

Merely by way of example, a region in the light guide column corresponding to the sixth material requires formation of small bubbles. Therefore, a temperature molding parameter of a first injection zone (e.g., a feeding zone) of the sixth injection channel is configured to 160°C (set based on the effective decomposition temperature range of the slow-acting foaming agent in this material). A pressure molding parameter is configured to 1.2 MPa. This preheats PMMA solid particles while avoiding premature decomposition of the slow-acting foaming agent. A temperature molding parameter of a second injection zone (e.g., a melting zone) of the sixth injection channel is configured to 180°C. A pressure molding parameter is configured to 1.0 MPa. This activates the slow-acting foaming agent (e.g., sodium bicarbonate compounded with citric acid) to stably release a gas (e.g., carbon dioxide) while limiting the bubble size. A temperature molding parameter of a third injection zone (e.g., a foaming activation zone) of the sixth injection channel is configured to 195°C. A pressure molding parameter is configured to 0.8 MPa. This controls the slow-acting foaming agent to work in a small amount, allowing the small bubbles to grow slowly and stably.

In some embodiments, cooling parameters for the first material to the seventh material are determined based on parameters of the bubbles inside each annular region of the light guide column.

Beneficial effects that may be brought by embodiments of the present disclosure include, but are not limited to: (1) by arranging bubbles in a single-layer or multi-layer in the first annular region, a plurality of reflections and/or refractions of light are achieved, thereby forming a circumferential light emission effect; (2) at least a portion of a luminous intensity distribution curve of the light guide column exhibits the serrated pattern, thereby forming a striped light effect with alternating bright and dark areas; (3) the entirely transparent light guide column achieves light emission based on refraction, avoiding the use of large-area milky white diffusing plates or soft light covers, while also achieving light diffusion and softening effects; (4) different bubble sizes and maximum bubble spacings within a single bubble layer are configured to obtain different light effects; (5) a double-layer bubble structure is arranged, with larger bubbles in an inner layer and smaller bubbles in an outer layer, achieving circumferential light distribution while further scattering and softening the light; (6) a larger number of bubbles are arranged in the outer layer to achieve denser refraction, thereby achieving a soft light effect; (7) a second accommodation space is formed at an end of the light guide column to accommodate electrical structures, reducing the exposure ratio of the electrical structures relative to an overall luminaire; (8) the second accommodation space hides a diffusing plate, preventing large-area milky white structures from affecting the visual appearance of the luminaire; (9) the light guide column is connected to a first housing and a second housing via the second accommodation space, forming a larger, aesthetically pleasing light guide column portion and a smaller, less observable lamp head portion; (10) heat dissipation hole(s) is/are formed on a second annular structure and may be hidden after installation; (11) bubble generation is achieved using a fast-acting foaming agent and a slow-acting foaming agent, and bubble size is controlled via temperature and pressure; (12) pressure control is used to cause migration of generated bubbles, thereby fine-tuning bubble positions; (13) temperature control is used to manage an operating state of the fast-acting foaming agent and the slow-acting foaming agent, controlling gas generation timing and quantity, thereby forming bubbles of different sizes and densities, or generating a mixture of bubbles with different sizes; (14) different light guide column materials are provided to each layer to form a multi-layer bubble structure, with bubbles of different sizes and densities formed within each layer; (15) a design method for a manufacturing process is provided, where a corresponding manufacturing process is obtained based on a desired form of the light guide column from a user, selecting appropriate raw materials, molding parameters, and cooling parameters. It should be noted that different embodiments may yield different beneficial effects. In different embodiments, the beneficial effects may be any one or a combination of the above, or any other potentially achievable beneficial effect.

The basic concepts have been described above. Clearly, to those skilled in the art, the foregoing detailed disclosure is merely by way of example and does not constitute a limitation on the present disclosure. Although not explicitly stated herein, those skilled in the art may make various modifications, improvements, and amendments to the present disclosure. Such modifications, improvements, and amendments are taught in the present disclosure, and therefore still fall within the spirit and scope of the exemplary embodiments of the present disclosure.

What is claimed is:

1. A light guide column, comprising: a columnar structure, wherein the columnar structure is made of a transparent material, an interior of the columnar structure includes at least one first annular region centered on an axis of the columnar structure, an interior of the at least one first annular region has bubbles; and
at least a portion of a luminous intensity distribution curve of the light guide column has a serrated pattern;
a count of the at least one first annular region is two or more, and the bubbles include first bubbles and second bubbles; and
an interior of one or more of the at least one first annular region has the first bubbles, and an interior of one or more remaining first annular regions has the second bubbles.

2. The light guide column according to claim 1, wherein the interior of the columnar structure further includes one or more second regions centered on the axis of the columnar structure, and the at least one first annular region and the one or more second regions are alternately arranged; and
the one or more second regions do not contain bubbles.

3. The light guide column according to claim 2, wherein the one or more second regions are one or more second annular regions.

4. The light guide column according to claim 1, wherein the luminous intensity distribution curve of the light guide column includes a first intensity distribution region and two second intensity distribution regions located on both sides of the first intensity distribution region;
the luminous intensity distribution curve in the first intensity distribution region has a transverse trend;
the luminous intensity distribution curve in each of the two second intensity distribution regions has an increasing trend or a decreasing trend; and
at least one of the luminous intensity distribution curve in the first intensity distribution region and the luminous intensity distribution curve in the each of the two second intensity distribution regions has a serrated pattern.

5. The light guide column according to claim 4, wherein the luminous intensity distribution curve in the first intensity distribution region has the serrated pattern; and
the luminous intensity distribution curve in the each of the two second intensity distribution regions includes a smooth section having a smooth shape and a serrated section having the serrated pattern, and the serrated section is adjacent to the first intensity distribution region.

6. The light guide column according to claim 1, wherein a diameter of the first bubbles is less than a diameter of the second bubbles.

7. The light guide column according to claim 6, wherein a first annular region containing the first bubbles surrounds an exterior of a first annular region containing the second bubbles.

8. The light guide column according to claim 7, wherein the diameter of the first bubbles is in a range of 1.5 to 2 mm, and a maximum spacing between adjacent first bubbles is selected from a range of 8 to 10 mm; and/or,
the diameter of the second bubbles is in a range of 5 to 7 mm, and a maximum spacing between adjacent second bubbles is selected from a range of 3 to 6 mm.

9. A luminaire, comprising the light guide column according to claim 1, wherein the luminaire comprises:
a housing, wherein one end of the housing is fixedly connected to the light guide column; and
a light source assembly, wherein the light source assembly is disposed within the housing.

10. The luminaire according to claim 9, wherein the housing includes:
a first housing, wherein one end of the first housing is fixedly connected to the light guide column;
a second housing, wherein the second housing is fixedly connected to the first housing, and the second housing closes another end of the first housing; and
the light source assembly is disposed within a first accommodation space formed by the first housing and the second housing, the first housing has a step portion, and the light source assembly is mounted on the step portion.

11. The luminaire according to claim 10, wherein the first housing includes: a first cylindrical structure, a second annular structure, and a third cylindrical structure connected in sequence; and
a diameter of the first cylindrical structure is greater than a diameter of the third cylindrical structure, a step surface of the step portion is formed at the second annular structure, and a circuit board of the light source assembly is fixed to the second annular structure.

12. The luminaire according to claim 10, wherein the columnar structure of the light guide column has a second accommodation space, and at least a portion of the first housing is disposed within the second accommodation space; and
the columnar structure of the light guide column is threadedly connected to the first housing.

13. The luminaire according to claim 12, further comprising: a diffusing plate, wherein the diffusing plate is disposed within the second accommodation space; and
the diffusing plate is configured to convert one or more point light sources provided by the light source assembly into a surface light source directed toward the columnar structure of the light guide column.

14. The luminaire according to claim 13, wherein an outer diameter of the diffusing plate matches an outer diameter of an end of the first housing proximate to the columnar structure, one end of the first housing abuts against one side of the diffusing plate, and another side of the diffusing plate contacts a bottom surface of the second accommodation space.

15. The luminaire according to claim 11, wherein the second annular structure is provided with a heat dissipation hole.

16. A method for manufacturing a light guide column, wherein the light guide column includes a columnar structure, the columnar structure is made of a transparent material, an interior of the columnar structure includes at least one first annular region centered on an axis of the columnar structure, and an interior of the at least one first annular region has bubbles; at least a portion of a luminous intensity distribution curve of the light guide column has a serrated pattern; and
the method comprises:
providing a light guide column material, wherein the light guide column material includes a material for forming the at least one first annular region, and the material includes a plastic material, a fast-acting foaming agent, and a slow-acting foaming agent;
performing temperature control and pressure control on the light guide column material to form the bubbles inside the light guide column material; and
performing cooling control on the light guide column material to cure the light guide column material, to obtain the light guide column.

17. The method according to claim 16, wherein the interior of the columnar structure includes the at least one first annular region and second regions centered on the axis of the columnar structure; and
the method further comprises:
providing the light guide column material, the light guide column material including a first material for forming a second region located on an inner portion, a second material for forming the at least one first annular region located in a middle portion, and a third material for forming a second region located on an outer portion, wherein each of the first material and the third material includes the plastic material, and the second material includes the plastic material, the fast-acting foaming agent, and the slow-acting foaming agent.

18. The method according to claim 16, wherein
the interior of the columnar structure includes the at least one first annular region and one or more second regions centered on the axis of the columnar structure, the at least one first annular region and the one or more second regions are alternately arranged sequentially from a center of the columnar structure to an outer portion of the columnar structure, a count of the at least one first annular region is at least two, an interior of one of the at least one first annular region has first bubbles, and an interior of another of the at least one first annular region has second bubbles; and
the light guide column material includes a first material for forming a second region located on an inner portion, a second material and a third material for forming two first annular regions located in a middle portion, a fourth material for forming a second region located between the two first annular regions, and a fifth material for forming a second region located on an outer portion, each of the second material and the third material includes the plastic material, the fast-acting foaming agent, and the slow-acting foaming agent, and each of the first material, the fourth material, and the fifth material includes the plastic material;
the method comprises:
independently performing temperature control and pressure control on the second material and the third material, respectively, to independently form the first bubbles and the second bubbles inside the second material and the third material, respectively; and
independently performing cooling control on the second material and the third material, respectively, to cure the light guide column material to obtain the light guide column.

19. The method according to claim 18, wherein the independently performing temperature control and pressure control on the second material and the third material, respectively, to independently form the first bubbles and the second bubbles inside the second material and the third material, respectively, includes:
melting the second material and the third material, while avoiding decomposition of the fast-acting foaming agent and the slow-acting foaming agent, and providing different pressures to the second material and the third material;
setting a temperature of the second material within the effective decomposition temperature range of the slow-acting foaming agent and the effective decomposition temperature range of the fast-acting foaming agent, to initiate decomposition of the slow-acting foaming agent and the fast-acting foaming agent; setting a temperature of the third material within the effective decomposition temperature range of the slow-acting foaming agent and lower than the lowest effective decomposition temperature of the fast-acting foaming agent, to initiate decomposition of the slow-acting foaming agent;
setting the temperature of the second material higher than or equal to the highest effective decomposition temperature of the fast-acting foaming agent, to completely decompose the fast-acting foaming agent; setting the temperature of the third material within the effective decomposition temperature range of the slow-acting foaming agent and the effective decomposition temperature range of the fast-acting foaming agent, to decompose the slow-acting foaming agent and the fast-acting foaming agent; and
reducing the temperature of the second material and the temperature of the third material, to set positions of the two first annular regions.

20. The method according to claim 19, wherein the setting a temperature of the second material within the effective decomposition temperature range of the slow-acting foaming agent and the effective decomposition temperature range of the fast-acting foaming agent, to initiate decomposition of the slow-acting foaming agent and the fast-acting foaming agent; and setting a temperature of the third material within the effective decomposition temperature range of the slow-acting foaming agent and lower than the lowest effective decomposition temperature of the fast-acting foaming agent, to initiate decomposition of the slow-acting foaming agent, further includes: performing first stirring on the second material, and performing second stirring on the third material; wherein:
a stirring speed of the first stirring is greater than a stirring speed of the second stirring.
